(19) United States
(12) Patent Application Publication
(10) Pub. No.: US 2025/0356365 A1
(43) Pub. Date: Nov. 20, 2025

(54) System and Method for Real-Time Identity-Free Personalization Using Fluid Emotional Trait Vectors, Modular Engine Mesh Architecture, Context-Aware Engagement Logic, and Adaptive Goal Mutation

(71) Applicant: Justin Ginsberg, Upper Saddle River, NJ (US)

(72) Inventor: Justin Ginsberg, Upper Saddle River, NJ (US)

(21) Appl. No.: 19/206,049

(22) Filed: May 13, 2025

(51) Int. Cl. G06Q 30/015

(52) U.S. Cl. CPC G06Q 30/015

(57) ABSTRACT

A system and method for real-time, identity-free personalization using deformable emotional trait vectors to dynamically adapt digital and voice-based experiences. Each user session is modeled as a behavioral object known as a Vectra, composed of fluidic traits—such as mass, viscosity, temperature, volatility, and texture—that evolve continuously in response to live behavioral, contextual, environmental, and voice-derived signals. These Vectras traverse a dynamically warped emotional space, the Vectraverse, influenced by ambient conditions including time of day, noise level, inventory urgency, and engagement rhythm. Gravitational pull toward predefined emotional goal attractors modulates system behavior, while a goal mutation engine reclassifies session intent when confidence decays or friction spikes. Outputs include tone modulation, content pacing, offer framing, and gamified reward logic—all executed without storing identity, login credentials, or historical profiles. The system supports modular deployment across voice, screen, signage, mobile, and in-room environments, and integrates with large language models, AI agents, and third-party personalization stacks via privacy-safe APIs and federated learning. Designed for zero-ID personalization, the platform enables emotionally intelligent, context-aware engagement across any surface or session.

A real-time personalization system that computes emotional trait vectors per session and uses goal mutation logic to adapt tone, offer, and reward behavior across any surface—without identity or stored history

Technical Field: This invention relates to systems and methods for real-time, privacy-compliant personalization of digital and voice-based experiences using behavioral, contextual, emotional, and environmental signal interpretation. More specifically, it pertains to identity-free session modeling via deformable emotional trait vectors (Vectras), dynamic goal inference and mutation, contextual field warping, and tone- and reward-based engagement modulation across multi-surface deployments. The invention supports modular orchestration across web, voice, signage, mobile, and ambient environments, enabling emotionally intelligent, adaptive interactions without reliance on identity, login, cookies, or persistent tracking.

Background of the Invention: Conventional personalization systems depend on static decision trees, identity-based targeting, cohort segmentation, or historical profiling. These approaches are inherently limited in their ability to respond fluidly to moment-by-moment user behavior and are increasingly incompatible with evolving privacy laws, user expectations, and real-time interaction surfaces. Legacy methods lack the emotional intelligence, adaptability, and compliance required in today's digital ecosystem—especially across voice interfaces, ambient displays, in-session assistants, and mobile or kiosk-based interactions.

Current systems also treat user intent as fixed, failing to account for mid-session shifts in emotional posture, cognitive load, or economic receptivity. They cannot mutate engagement goals, reverse course when friction arises, or recalibrate tone and pacing based on contextual pressure such as noise, time of day, inventory urgency, or voice hesitation. Furthermore, most personalization logic breaks across surfaces and channels, offering no continuity when a user transitions from screen to voice, from signage to mobile, or from chatbot to call.

What is needed is a real-time, zero-identity personalization engine that models each session as a fluid, emotional object—interpreting behavioral signals as dynamic trait vectors, adapting goal strategy in response to confidence decay or volatility, and delivering emotionally aligned content, tone, offer framing, and rewards without requiring login, cookies, profiles, or persistent tracking. This system must operate across environments, adapt to contextual warp fields, and support multi-surface continuity—enabling deeply personalized yet privacy-compliant experiences for every user, in every moment.

Existing personalization methods primarily rely on identity-based architectures, including persistent cookies, device fingerprinting, CRM databases, logged-in user profiles, and static A/B testing frameworks. These approaches inherently depend on historical user data and user identity, presenting significant limitations in dynamic emotional adaptability, real-time responsiveness, and compliance with emerging global privacy regulations (e.g., GDPR, CCPA, HIPAA, FERPA). Further, while existing emotional modeling methods, such as sentiment analysis systems or emotion-classification machine learning frameworks, typically offer retrospective or generalized emotion detection, they do not adapt dynamically to mid-session behavioral changes nor support real-time goal mutation based on live emotional confidence decay and environmental signals. Thus, conventional systems remain static, cohort-based, slow in adaptation, prone to manipulation, and incapable of privacy-native personalization. In contrast, the present invention uniquely addresses these limitations by introducing real-time, identity-free personalization, employing dynamically mutable emotional trait vectors, session-specific confidence decay models, contextual warping, and cross-surface orchestration without user identification or persistent tracking—representing a substantial advancement over prior art.

### SUMMARY OF THE INVENTION

### Plain-Language Brief Summary

This invention introduces a new way for digital systems—like websites, kiosks, vending machines, or voice assistants—to adapt in real time without knowing who you are. Instead of relying on cookies, logins, or stored history, the system observes live behaviors during a single session—like hesitation, scroll speed, or repeated gestures—and responds to emotional cues such as confidence, curiosity, or frustration.

Imagine a vending machine that picks up on your indecision and gently offers reassurance, or a website that tones down its messaging when it detects you're feeling overwhelmed. Each visit becomes a unique emotional journey. The system doesn't just personalize—it responds to the vibe of the moment, adapting its tone, timing, offers, and rewards in a respectful, privacy-safe way.

At its core is a fluid emotional model where traits like urgency or hesitation naturally fade back to a neutral baseline unless reinforced. This allows the experience to remain responsive and emotionally coherent as the user's state evolves—without tracking, identity, or stored history.

By working across phones, smart signage, voice assistants, and more, this platform helps companies deliver emotionally intelligent, human-centered experiences that honor both the user's mood and their right to privacy.

The first personalization system that responds to vibe—not identity.

### Full Summary of Invention

The invention provides a system and method for real-time, identity-free personalization by modeling each user session as a deformable behavioral-emotional object called a Vectra. Each Vectra is instantiated at session onset and continuously evolves in response to live behavioral inputs, contextual overlays, environmental conditions, and optionally voice-based interactions. The Vectra is characterized by a multidimensional trait vector—including mass (confidence), viscosity (resistance), temperature (urgency), volatility (instability), elasticity (rebound), and surface texture (friction)—which governs its dynamic behavior within a warped engagement field known as the Vectraverse.

A Field Input Decoder ingests moment-level signals such as scroll patterns, dwell timing, rage taps, ambient noise, search terms, inventory pressure, crowd proximity, or voice hesitation. These inputs continuously deform the engagement space, recalibrating gravitational forces, goal thresholds, and emotional inertia. The system maintains a registry of over 25 emotional goal attractors (e.g., Convert, Delay, Reassure, Celebrate), each with a gravitational tone profile. Unstable attractors are designed to trigger emotional pacing shifts and reframe the session trajectory. While goal attractors are defined as discrete nodes for interpretability and orchestration purposes, the system supports a continuous range of engagement goals through real-time trait vector modulation. This allows for infinite nuance—e.g., ‘Convert with uncertainty,’ ‘Delay with optimism,’ or ‘Reassure under time pressure’—each inferred from unique combinations of emotional trait vectors and environmental overlays.

In contrast to systems that rely on discrete, binary goal transitions, the present invention includes a gradient goal blending engine that continuously evaluates gravitational pull across multiple engagement attractors. Rather than selecting a single goal at any given time, the system supports simultaneous weighting of multiple goals—such as “40% Convert,” “60% Reassure”—based on the evolving emotional trait vector of the session. This allows tone, offer framing, content pacing, and reward exposure to be blended proportionally to the user's current emotional posture, enabling smoother transitions, more emotionally coherent outputs, and a complete architectural replacement for static A/B testing models.

A Trajectory Resolver calculates the Vectra's motion path and emotional posture, while a Goal Mutation Engine reclassifies the session objective when trait decay, volatility spikes, or contextual field pressure exceeds calibrated thresholds. The system supports both goal mutation and reversal, enabling emotionally intelligent pivots throughout the session without relying on cookies, identity, or stored history.

The core emotional traits—computed by VectraIQ—are used in real time by modular engine components, including:
IntentIQ (goal mutation and reclassification),
MomentIQ (tone modulation and timing orchestration),
AffordIQ (economic and offer logic),
BonusIQ (reward readiness and incentive exposure), and
RecallIQ (privacy-safe reinforcement learning and trait tuning).

Together, these engines generate personalized system outputs, including dynamic tone, CTA suppression or escalation, offer framing, reward gating, and response timing. All decisions occur within the current session boundary and are optionally logged as ephemeral explanation tokens for compliance or explainability, without storing identity, biometric data, or persistent user history.

The system supports deployment across websites, mobile apps, kiosks, signage, ambient displays, automotive dashboards, voice assistants, and telephone systems. It offers edge and offline fallback modes and is capable of multi-user arbitration in shared displays. Emotional state tokens may be passed across surfaces (e.g., kiosk to mobile) using non-identifying Vectra handoff logic.

This architecture enables modular licensing of the XyloIQ system and its subcomponents—including SiteIQ, AdIQ, AmbientIQ, and VoiceIQ—into vertical-specific solutions governed by field-of-use restrictions. The preferred embodiment operates as a unified zero-ID personalization framework that adapts to each user's emotional posture, contextual moment, and behavioral signature, all while preserving privacy and session-local integrity.

This system may be licensed in whole or in modular subcomponents—including but not limited to VectraIQ, IntentIQ, MomentIQ, BonusIQ, AffordIQ, RecallIQ, and AmbientIQ—under restricted field-of-use conditions. Such use cases include, but are not limited to: retail, healthcare, education, automotive interfaces, voice assistance, programmatic advertising, digital signage, connected television (CTV), or in-room ambient displays. Licensing terms may be scoped by surface, industry vertical, region, or compliance context.

The system is architected for modular licensing, enabling each engine—VectraIQ (emotional trait modeling), IntentIQ (goal mutation), MomentIQ (tone control), AffordIQ (offer framing), BonusIQ (reward logic), and RecallIQ (learning)—to operate independently or in combination. Each module may be licensed, rebranded, or deployed via white-label APIs, SDKs, or edge containers for use in third-party platforms such as digital assistants, smart signage, eCommerce engines, loyalty systems, or in-app personalization layers. Licensing may be restricted by vertical, deployment surface, geography, or regulatory context. All modules maintain zero-identity compliance by design, making the system immediately deployable in regulated, privacy-sensitive, or OEM contexts—without revealing internal trait logic or requiring user tracking.

The system is fully compatible with large language model (LLM) architectures, including systems such as OpenAI's GPT, Google Gemini, Amazon Bedrock, Claude by Anthropic, and other generative AI frameworks. VectraIQ outputs can be consumed by these models as emotional state modulation tokens—governing tone, pacing, and message complexity in real time. This enables identity-free, emotionally aligned generative responses across voice agents, search assistants, and interactive chat environments.

This architecture supports cross-brand emotional continuity through non-identifying trait tokens. These ephemeral tokens preserve tone, goal state, and reward readiness as users transition across brands, apps, or devices—without requiring login or persistent tracking. This unlocks new licensing pathways for federated personalization ecosystems while maintaining full zero-ID compliance.

The present invention focuses on in-session personalization. A future continuation-in-part may expand this architecture to include multi-agent arbitration, generative character alignment, or multi-session Vectra continuity in persistent environments, enabling persistent emotional personalization without compromising identity-free principles.

### Use Case Examples:

1. Google Search
   User scrolls rapidly, stops, and clicks “return” twice. Elevated volatility and friction detected. AdIQ reduces CTA pressure in retargeting.
2. YouTube
   Viewer skips ads quickly and posts a comment. Trait pattern suggests emotional fatigue. Tone modulation reduces intensity in future recommendations.
3. Coffee Shop Kiosk
   User hovers on “hot chocolate combo” but doesn't tap. High viscosity and delayed engagement timing. BonusIQ holds reward. MomentIQ offers low-pressure suggestion.
4. Amazon.com
   User hovers repeatedly on return policy. Confidence decay+entropy increase. AffordIQ reframes options with comparison layout, no urgency tone.
5. Alexa
   User pauses mid-command and says “wait . . . ” twice. Temperature drop and micro-hesitation spike. VoiceIQ slows response and softens language.
6. Vending Machine
   User browses for 45 seconds during finals week in noisy setting. Viscosity and ambient stress increase. Display tone softens to reduce overload.
7. Airport Gate Display
   Crowding increases after a gate change. Movement rhythm becomes erratic. AmbientIQ adjusts messaging tone to minimize escalation.
8. Hotel Room TV
   Guest spends several minutes on spa menu with no selection. High dwell+low confidence. CTA suppressed. System offers optional reminder message.
9. Car Wash Kiosk
   User toggles options rapidly, then times out. Texture and reversal traits elevate. System simplifies display and removes CTA pressure.
10. LLM Chatbot
   User deletes and retypes message slowly. Friction and viscosity rise. Response tone minimized. Follow-up presented as a gentle prompt.
11. Google Ads
   User bounces quickly after click-through. Friction signals passed from SiteIQ to AdIQ.
   Next ad campaign uses softer framing with no countdown.
12. HVAC Sales (iPad)
   Sales rep taps screen to log hesitation. Confidence decay detected. Offer shifts to longer-term payment framing with tone suppression.
13. McDonald's Kiosk
   User hesitates between family meals and scrolls back. Increased texture and hover delay.
   System presents neutral comparison view.
14. Starbucks POS
   User pauses at tip screen, then selects minimum. Confidence drop+friction pattern. Tone softens with acknowledgment of customer choice.
15. Retail Checkout Screen
   User reopens item list at checkout. Confidence declines. AffordIQ offers split payment option in neutral framing.
16. On-Hold Messaging
   Caller is silent for 90 seconds. Viscosity high, entropy rising. Voice response slows and inserts comfort message.
17. Digital Signage (Retail)
   Viewers pause but don't scan QR. Trait density low, dwell high. Messaging shifts from promo to educational tone.
18. Mobile eCommerce App
   User bookmarks multiple items after long exploration. Confidence stable, but no action taken. CTA replaced with “save for later.”
19. Car Dealership Tablet
   Buyer slows during finance screen navigation. Confidence decays. Sales display reframes offers with longer timelines and fewer CTAs.
20. Retail Smart Mirror
   User looks without gesture interaction. Inferred high viscosity and low temperature.
   Messaging offers alternatives with no CTA trigger.
21. Medical Intake Tablet
   User reopens risk disclosure and lingers. Trait profile: high friction, low confidence.
   Tone shifts to soft reassurance without escalation.
22. Law Firm Website
   User loops between FAQ and “book consult” form. Volatility increases. SiteIQ delays
   CTA exposure and shows side-by-side service clarity.
23. Cruise Cabin Display
   Guest returns to spa menu daily but takes no action. Confidence doesn't reinforce.
   Display offers optional reminder with no urgency.
24. Retail POS Tablet
   User adds and deletes item repeatedly. Texture and reversal spike. AffordIQ delays upsell and offers flexible pricing.
25. Airline App (Boarding Gate)
   User toggles between “change seat” and “upgrade.” Crowd noise and decision friction detected. Upsells paused. Visual tone softens.
26. Meditation App
   User skips voice styles and pauses on silent screen. Confidence rebounding, friction dropping. System holds rewards, enters silent tone mode.
27. Smart Thermostat Panel
   User increases temperature repeatedly. Trait mapping indicates rising friction. Eco-mode CTAs suppressed to prevent conflict.
28. Museum AR Display
   User avoids war exhibit, dwells at sculpture. High emotional volatility. AmbientIQ softens upcoming zone tone and light transitions.
29. E-Learning Platform
   Learner replays video twice, edits quiz answer. Trait vector: cognitive friction+confidence decay. Hints activated. CTA pacing delayed.
30. Voice Assistant in Car
   User reissues music request in quieter tone. Viscosity and friction traits rise. VoiceIQ lowers tone and removes secondary prompts.
31. Parenting App at Night
   User scrolls logs slowly and reopens sleep tips. Trait set=high viscosity, low confidence.
   System holds advice CTA and presents encouragement.
32. Adult Content App
   User browses same category repeatedly without engagement. Emotional posture: curiosity loop with texture increase. Escalation paused, CTA withheld.
33. Grief Support Page
   User starts tribute form but closes early. Volatility spike with immediate withdrawal.
   BonusIQ withheld. Interface enters reflection mode.
34. Restaurant Kiosk
   User loops through combos and pauses. Trait pattern indicates hesitation. Menu shifts to side-by-side comparisons with no pressure CTA.
35. Fitness Mirror
   User cancels workout, opens stretching module. Confidence decay followed by elasticity rebound. Pacing slowed. Encouragement tone enabled.
36. EV Dashboard
   Driver checks range repeatedly while battery low. Emotional indicators: urgency, volatility. Charging option shown softly. Upsell removed.
37. School Tablet (IEP Student)
   Student opens help twice during quiz. Trait: high viscosity, cognitive strain. BonusIQ gated. Tone softens. Pacing adjusted.
38. Elevator Display in Hospital
   AmbientIQ detects crowd and downward elevator traffic. Trait overlay predicts stress.
   Messaging shifts from promotional to comfort mode.
39. Digital Banking App
   User revisits interest rate FAQ during loan flow. Friction and hesitation high. CTA reframed from “Apply Now” to “Compare Safely.”
40. Retail Smart Mirror
   User looks but doesn't gesture. Trait vector shows hesitation with low density. Message changes to “Want to see more styles?” without urgency.

### Example Deployment Scenarios in Commerce, Voice, Advertising, and Retail Environments

The following non-limiting deployment scenarios illustrate how the invention may be applied across various interaction environments, including eCommerce platforms, voice assistants, smart kiosks, advertising surfaces, and search interfaces. In each case, the system adapts engagement strategy, tone, pacing, offer logic, or reward readiness based on the session-local Vectra trait state, without requiring identity, persistent tracking, or stored history.

1. eCommerce Product Page Personalization

In an eCommerce context, the system may monitor hover behavior on return policy links, repeated scroll-back events, and checkout abandonment loops. When the Friction Index and Texture traits exceed configured thresholds, and Confidence decays below the mutation threshold, IntentIQ triggers a goal reclassification from Convert to Reassure.
MomentIQ softens interface tone, delays urgency animations, and modifies CTA language (e.g., from “Buy Now” to “Explore Options”).
AffordIQ reframes the offer using a risk-reducing template (“Try now, cancel anytime”).
BonusIQ suppresses gamified reward exposure until emotional stability is restored.

### 2. Voice Assistant Interaction

In a voice interface deployment, the system may ingest live speech inputs and rhythm signals via VoiceIQ. If a user repeats a question with increasing pauses or hesitations (e.g., “Alexa, wait . . . should I cancel?”), the system detects friction escalation and Confidence decay.
VoiceIQ extracts elevated Friction and Texture traits.
IntentIQ mutates the goal from Convert to Reassure.
MomentIQ slows reply pacing, softens voice tone, and suppresses follow-up prompts.

This allows the voice assistant to adaptively regulate tone and content without requiring voice ID, login, or behavioral history.

### 3. Smart Retail Kiosk

In a retail kiosk setting, such as a checkout or in-store browsing terminal, the user may toggle between product bundles, pause on price comparison tiles, and exhibit gesture reversal loops. When Viscosity and Texture rise and Temperature drops, the Vectra enters a Delay state.
SiteIQ delays CTA exposure and deactivates escalation offers.
AffordIQ adjusts offer logic to emphasize optionality and remove countdowns.
BonusIQ withholds reward activation to prevent misaligned motivation.

All logic occurs locally on-device, with no network-required user profile or persistent session record.

### 4. Real-Time Ad Rendering

When a behavioral session trait token is passed to a dynamic ad rendering engine (e.g., a real-time creative platform), AdIQ provides a tone modulation directive based on current Vectra state.
Trait example: goal: “Reassure”, confidence: 0.4, friction: 0.7
The ad engine selects a creative variant with softened language and reduced urgency.
This real-time adjustment ensures emotional alignment per impression, with no retargeting ID or profile linkage required.

### 5. Search Query Goal Mutation

In a search interface, query rephrasing, typing cadence, and correction loops are monitored via SearchIQ. If the system detects multiple rewrites and hesitant modifiers (e.g., “cheap,” “safe,” “how to choose”), the Confidence trait decays while Texture increases.
IntentIQ mutates the goal from Convert to Educate.
MomentIQ adjusts visual tone of results (e.g., shifts from “Best Deal” banners to “Comparison” modules).
AffordIQ suppresses offers unless the Emotional Mutation Readiness Score (EMRS) returns to baseline.

The goal shift and content modulation occur entirely session-locally, without tracking prior searches or requiring login.

### 6. Connected Television (CTV) Environment

On a CTV interface, such as a streaming application with interactive overlays, the system monitors navigation patterns, pause timing, and decision hesitation.
If viscosity rises during an upsell moment (e.g., subscription tier promotion), the system delays CTA presentation and replaces assertive language with neutral comparative framing.
BonusIQ reward animations (e.g., “Unlock a bonus episode”) are suppressed until confidence rebounds.

This ensures emotional congruence with the viewer's state without user account access or device fingerprinting.

### 7. Retail Point-of-Sale (POS) Checkout Tablet

In a physical retail environment utilizing a touchscreen checkout or loyalty tablet, the system ingests real-time behavioral signals including prolonged dwell time on payment selection, hesitation during tip input, and repeated navigation to prior summary screens.
IntentIQ detects Confidence decay and Friction elevation, resulting in a goal mutation from Convert to Delay or Reassure.
MomentIQ modifies interface tone from assertive to minimalist, delays escalation of optional tip or upsell prompts, and softens visual presentation.
BonusIQ suppresses reward animation triggers and CTA pulsing until the Vectra's viscosity and volatility normalize.

All trait state processing occurs session-locally and is discarded at session termination without requiring user login or stored purchase history.

### 8. In-Aisle Mobile App Behavior

In a mobile shopping application used by a customer navigating physical store aisles, the system tracks item scanning behavior, repeat inspection of return policies, and toggling between high and low price filters.
AffordIQ calculates an elevated Affordability Index and down-prioritizes urgency-framed bundles or payment promotions.
IntentIQ may mutate the session goal from Convert to Educate or Reassure.
MomentIQ reframes tone to emphasize clarity, comparison, or passive exploration.
BonusIQ defers reward eligibility and surfaces symbolic tokens only if confidence rebounds and friction subsides.

These adaptations support in-aisle decisioning without GPS, identity, or persistent tracking.

### 9. Shelf-Edge Signage and Smart Displays

In a retail setting using ambient or shelf-edge digital signage, the system may project a Vectra using passive signal inputs including group dwell duration, proximity density, and prior display exposure intervals.
AmbientIQ computes a projected trait vector, where elevated viscosity and volatility suggest hesitation or sensory overload.
The system reduces animation cadence, de-escalates language framing (e.g., from “Act Now” to “Take a Look”), and withholds countdowns or limited-time indicators.

Projected trait vectors are time-limited, location-scoped, and never linked to any identifiable signal source.

### 10. On-Device Product Search and Filter Interaction

In an eCommerce or retail mobile app, the system ingests interaction telemetry such as filter toggling, price sort selection, and query reformulation loops.
SearchIQ computes a trait delta indicating decaying confidence and increasing texture.
IntentIQ reclassifies the goal from Convert to Delay or Educate based on trait thresholds.
MomentIQ suppresses urgency-tagged results (e.g., “Last Chance,” “Limited Stock”) and surfaces tone-aligned modules like comparisons or explainer content.
AffordIQ delays incentive exposure or reframes pricing offers in softened language.

No personalization state is retained between sessions, and all signal-derived trait models are ephemeral.

### 11. Loyalty App Reward Exposure Logic

In a loyalty rewards or promotion-based application, BonusIQ monitors user interaction velocity, scroll plateaus, and exit-reentry frequency.
High Viscosity and Confidence decay suspend gamified elements such as spin wheels, streak counters, or animated bonuses.
Symbolic rewards (e.g., “Thanks for visiting!”) are substituted in place of economic incentives until trait posture improves.
RecallIQ tracks anonymous trait-to-outcome correlation, adjusting future reward exposure timing to maximize emotional alignment.

No reward eligibility or engagement pattern is stored beyond the current session boundary.

### 12. Social Feed and Messaging Adaptation in Social Platforms

In a social media environment comprising a scrolling content feed and embedded messaging interfaces, the system continuously monitors engagement rhythm, post hesitation patterns, and re-engagement loops.
MomentIQ computes Tone Activation Scores based on observed friction and scroll fatigue, and dynamically adjusts visual pacing of posts, suppresses autoplay media, or modifies caption tone presentation (e.g., replacing “See Offer” with “Learn More”).
IntentIQ mutates session goals when friction rises and confidence decays—e.g., from Convert to Delay or Educate—triggering tone de-escalation in call-to-action elements.
In messaging environments, SearchIQ or VoiceIQ detects increased typing latency, message deletions, or clarification requests, and modulates response prompts to reflect emotional readiness (e.g., shortening follow-up queries or softening NLP-generated suggestions).

All behavioral signals are processed session-locally, and no identity, stored history, or profile segmentation is required.

### 13. On-Device Personalization in Mobile and Voice Interfaces

In an operating system-level mobile environment supporting voice, touch, and notification surfaces, the system ingests tap cadence, notification dismissal patterns, and voice query rhythm.
VoiceIQ modulates voice assistant responses when repetition or correction behavior occurs, indicating increased Viscosity or Confidence decay. Tone is softened, pacing delayed, and complex multi-step responses withheld until goal reversal or recovery.
MomentIQ modifies lock-screen CTA phrasing and notification grouping logic in response to low temperature or elevated friction traits (e.g., “Explore Offers”→“Open When Ready”).
AffordIQ can delay promotional overlays or subscription offers in the app store or news content modules based on elevated Texture or volatility patterns during early onboarding or late-night device usage.

All trait state computation occurs on-device, and emotional adaptation proceeds without requiring login, cookies, or cross-session data.

### 14. Productivity and Assistant Modulation in Work Environments

In a productivity software environment containing document editors, calendar scheduling interfaces, and digital assistant modules, the system tracks user action cadence, rephrasing behavior, idle gaps, and micro-interruptions.
RecallIQ aggregates anonymous success patterns from users who abandoned tasks after high-friction interactions (e.g., re-editing the same paragraph or toggling meeting availability repeatedly).
IntentIQ mutates session goals when user rhythm degrades (e.g., Convert→Reassure), allowing MomentIQ to delay AI-generated suggestions, soften assistant tone, or insert optional phrasing (“Would you like help?” rather than “Do this now”).
AffordIQ delays upsell modules or software license extension prompts if volatility is high, indicating that conversion pacing should be deferred.

All decisions are session-local and auditable via the Compliance Token Layer (CTL), with no dependence on enterprise login or historical user telemetry.

### 15. Streaming Interface Adaptation and Recommendation Pacing

In a media streaming environment with autoplay, recommendation carousels, and skip-forward capabilities, the system continuously evaluates user interaction rhythms such as pause frequency, title rejection loops, and rewatch patterns.
IntentIQ triggers goal mutation when Confidence decays and Viscosity increases due to session fatigue, misalignment, or nighttime viewing-shifting from Convert to Delay or Reassure.
MomentIQ suppresses autoplay, simplifies recommendation rows (e.g., from “Top Picks for You” to “Explore More”), and softens tone overlays (e.g., “Watch Now”→“Take a Look”).
BonusIQ withholds gamified watch incentives or promotional episode unlocks when friction or entropy thresholds are exceeded.

All adaptations are made without requiring login, viewing history, or identity linkage, and are driven by real-time trait computation derived from passive interface behavior.

### 16. Adaptive Commerce Plugin Behavior in Retail Platforms

In a merchant-facing eCommerce platform plugin (e.g., embedded within a product detail page, checkout module, or promotional overlay), the system processes live session telemetry such as scroll behavior, pricing filter toggles, CTA hover stalls, and product return policy re-examination.
AffordIQ evaluates a live Affordability Index and Emotional Impact Score (EIS) based on pricing sensitivity signals, cart volatility, and payment hesitations.
IntentIQ mutates the session goal if trait values indicate a drop in Confidence and an increase in Friction or Texture-triggering MomentIQ to reframe CTA phrasing and suppress “Limited Time” language.
BonusIQ delays incentive exposure (e.g., “Spin to Save” or “Unlock Bonus”) until Confidence rebounds or session Viscosity drops.

All personalization logic occurs through client-side SDKs or browser extensions, with zero cookies, identity profiles, or cross-session tracking.

### 17. Emotionally Aligned Personalization in Healthcare Portals

In a digital health context—such as a patient portal, risk assessment tool, or care scheduling interface—the system continuously monitors behavior such as hesitation near risk disclosures, slow progression through medical consent forms, and abandonment or re-entry patterns.
MedIQ detects elevated Friction and Confidence decay, triggering a goal mutation from Convert to Reassure.
MomentIQ delays CTA exposure, reduces interface animation intensity, and shifts tone to soft, non-escalatory language (e.g., “Review Later” rather than “Book Now”).
BonusIQ suppresses all incentive, loyalty, or gamified elements while in a medical decision context or high-emotional-volatility state.

No identifiable medical history, patient login, or profile data is required. All trait computation and adaptive behavior operates session-locally with compliance to HIPAA, FERPA, GDPR, and the EU AI Act.

### 18. Adaptive Interface Modulation in Merchant Commerce Platforms

In a self-service commerce platform environment used by merchants for storefront setup, promotional campaign management, or checkout customization, the system monitors behavioral signals such as click pacing, field hesitation, tab-switching behavior, and form re-entry.
IntentIQ detects Confidence decay and elevated Viscosity during offer configuration or promotional tool usage, resulting in a goal mutation from Convert to Educate.
MomentIQ shifts the user interface tone to minimalist or educator modes, delays tooltips with urgency-based messaging, and introduces fallback examples or walkthroughs in place of standard CTAs.
BonusIQ withholds gamified merchant rewards (e.g., promotional credits or engagement streaks) during periods of elevated volatility or confidence instability, and only reactivates such elements once trait stabilization is detected.

All trait interpretation and mutation logic is performed using a browser-based SDK or embedded plugin, with no requirement for merchant account linking, behavioral history, or persistent identifiers. Trait values are computed, used, and discarded entirely within the session boundary.

### 19. Emotionally Tuned Engagement and CTA Modulation in Financial Applications

In a digital banking or fintech platform involving credit evaluation, loan application, investment decisions, or high-risk transactions, the system ingests live behavioral signals including hesitation on APR or risk disclosure elements, repeated adjustment of input ranges, or pause-before-submit behavior.
IntentIQ monitors trait trends and mutates session goals from Convert to Delay or Reassure when Confidence decays and Friction increases during financial disclosures.
MomentIQ suppresses time-sensitive call-to-actions (e.g., “Apply Now”) and reframes messages to non-pressuring alternatives (e.g., “Compare Options” or “We'll Save This for You”).
AffordIQ evaluates real-time Economic Impact Scores to determine whether offer presentation is emotionally and contextually viable. High friction combined with low EIS results in offer suppression or deferral.
BonusIQ is paused entirely during compliance-triggering states, ensuring that incentive framing is never applied during emotionally fragile financial sessions.

### Detailed Description—Trait Engine

Unlike traditional emotional modeling methods—such as conventional sentiment analysis algorithms (which primarily classify fixed emotional states from historical or static text inputs), facial recognition-based emotional systems (which require biometric identification or persistent storage of biometric features), or standard machine learning classifiers (which rely on training data linked to identifiable profiles)—the present invention employs a novel approach defined herein as “Vectra-based behavioral-emotional modeling.” Specifically, each anonymous user session is represented dynamically as a “Vectra,” a multi-dimensional emotional-behavioral construct that actively mutates goals, adjusts tone and offers in real-time, and navigates a warped emotional decision space (“Vectraverse”) based on session behavior and environmental signals without ever requiring user identification or stored profiles. This invention further uniquely integrates real-time mutation logic—enabling mid-session pivots in user engagement strategies (e.g., Convert→Reassure→Educate)—and applies sophisticated confidence decay models that dynamically reduce reliance on outdated session signals, adapting instantaneously to moment-level user uncertainty, hesitation, and behavioral friction.

Moreover, the present invention explicitly replaces the static cohort-based method of traditional A/B testing with real-time dynamic sequencing and emotionally intelligent offer logic. Unlike traditional A/B testing systems—which are incapable of real-time session-level adaptation, slow to converge on optimal outcomes, and ineffective at addressing individual emotional nuances—this invention continuously recalibrates the engagement strategy based on immediate session context, moment-by-moment emotional trajectory, and environmental volatility. Such capabilities are neither present nor technically feasible in traditional methods.

The Trait Engine is a core component of the XyloIQ platform responsible for generating and updating a dynamic emotional state model during the course of a session. It continuously translates real-time user interactions and environmental context into a deformable, multi-dimensional trait vector. This vector represents the current behavioral-emotional posture of the session and informs downstream decision logic across the personalization stack.

Each session initializes a unique Vectra, which serves as the fluid behavioral object. The Vectra evolves through time in shape, texture, momentum, and resistance based on interaction signals and contextual modulation. The Trait Engine computes and updates the following emotional-fluid properties:

| Prior Art Method | Limitations & Differences | How Current Invention Overcomes |
|---|---|---|
| Persistent Cookie & | Identity-dependent, privacy- | Fully identity-free, session-only |
| CRM-based | invasive, static profile reliance, | behavioral-emotional modeling; real- |
| Personalization | limited real-time emotional | time dynamic adaptation |
| | adaptability | |
| Conventional A/B | Slow, cohort-based, no real- | Real-time dynamic goal mutation, |
| Testing | time adjustments, static | continuous confidence scoring and |
| | outcomes | emotional responsiveness |
| Sentiment Analysis | Static emotional state | Real-time emotional confidence decay, |
| (ML-based) | classification, retrospective | dynamic emotional trait vectors, live |
| | analysis, no live goal mutation | session-level goal mutation |
| Biometric Emotion | Privacy-invasive, | level emotional modeling, anonymous |
| Detection (Facial or | identification-based, biometric | Identity-free, privacy-native session- |
| Voice Recognition) | storage risks, high regulatory | voice-derived emotional detection |
| | hurdles | without biometric storage |

### Core Trait Definitions

1. Temperature
   Represents emotional arousal or intensity. Higher temperature indicates urgency, impulsiveness, or rapid interaction cadence. Lower temperature reflects hesitancy, passivity, or decision fatigue.
2. Viscosity
   Represents emotional resistance or cognitive drag. High viscosity indicates friction, slowness, or overwhelm; low viscosity reflects responsiveness and ease.
3. Texture
   Captures behavioral volatility. Smooth texture suggests consistent, confident behavior, rough texture indicates instability, reversal patterns, or conflicting signals.
4. Density
   Reflects cognitive load and engagement intensity. High density results from frequent multi-mode interaction; low density suggests minimal signal diversity.
5. Friction Index
   A real-time measure of interaction difficulty, typically derived from reversals, backtracks, tap stalls, and CTA avoidance.
6. Confidence
   A synthetic score representing directional clarity and behavioral decisiveness. It is used to determine mutation triggers, goal certainty, and engagement viability.

### Trait Computation Model

Each trait is computed from normalized session telemetry inputs and updated in real time using scalar weighting and time-decay.

### Example Trait Formulas:

$$csharp \qquad Copy \qquad Edit$$

$$Temperature ( T ) = {α}_{1} \times AvgTapSpeed + {β}_{1} \times ScrollVelocity + {γ}_{1} \times SignalDensity$$

$$Viscosity ( V ) = {α}_{2} \times FrictionIndex + {β}_{2} \times IdleDuration + {γ}_{2} \times GestureReversalCount$$

$$Texture ( X ) = {α}_{3} \times VolatilitySpikeRate + {β}_{3} \times InterfaceTurbulence$$

$$Density ( D ) = {α}_{4} \times SignalCohesion / TraitConflictRatio$$

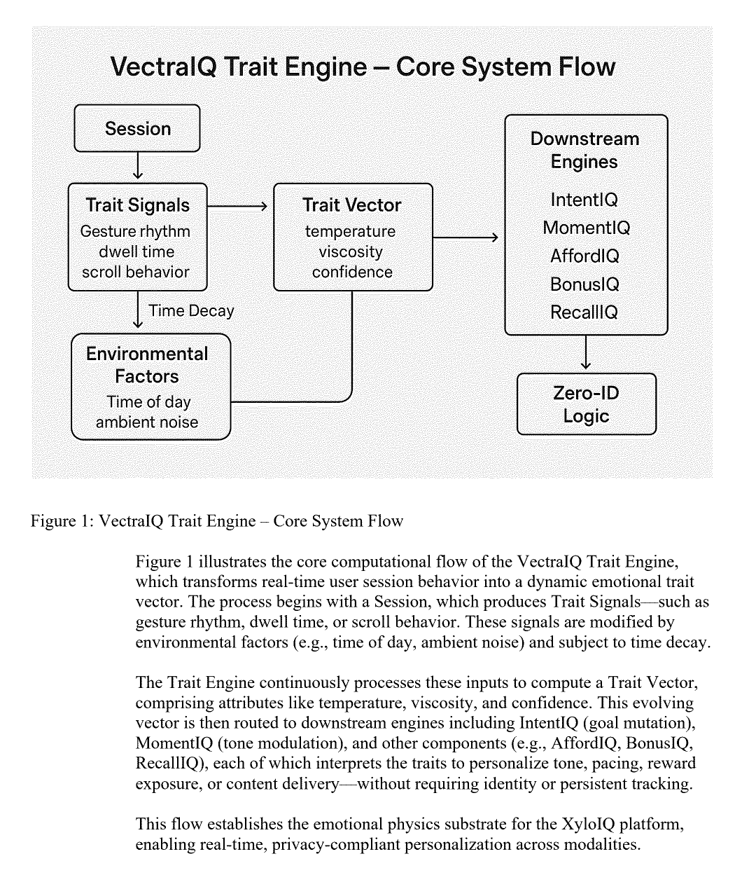

FIG. 1: Core Trait Computation Formulas—This set of equations defines how the VectraIQ engine calculates session-level emotional traits: Temperature (T), Viscosity (V), Texture (X), and Density (D). Each trait is derived from weighted behavioral signals (e.g., tap speed, scroll velocity, gesture reversals) and reflects the user's moment-to-moment emotional posture. These computed traits drive goal mutation, tone modulation, and reward logic across the engine stack.

### Where:

αₙ, βₙ, γₙ are environmental or channel-calibrated coefficients,
All signals are normalized to values between 0 and 1 for cross-device consistency.

### Friction Index:

$$ini \qquad Copy \qquad Edit$$

$$FrictionIndex = ( ReversalCount + ScrollBackCount + CTA\_AvoidanceEvents ) / SessionInteract$$

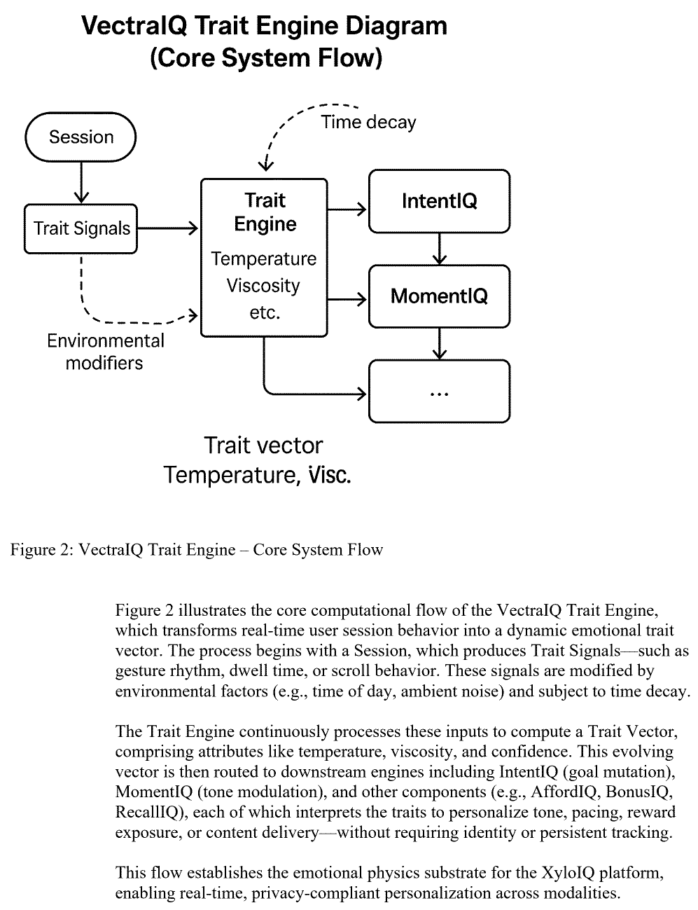

FIG. 2: Friction Index Calculation—This formula computes the Friction Index by dividing the sum of user hesitation signals (reversal events, scroll-backs, and call-to-action avoidance) by total session interactions. A higher Friction Index indicates increased resistance or uncertainty, and is used to trigger tone softening, CTA suppression, or reward delay in high-friction sessions.

This metric is used to regulate mutation thresholds and trigger tone suppression or CTA delay events.

### Time-Decay Dynamics

Each trait decays over time unless reinforced, simulating the diminishing relevance of past behavior. This is critical for real-time adaptability.

$$Copy \qquad Edit$$

$$Trait\_i ( t ) = {Trait\_i}_{0} \times e \hat{} ( - {λ}_{1} \times t )$$

FIG. 3: Trait Time-Decay Function—This exponential decay equation governs how emotional trait values (e.g., confidence, temperature, viscosity) diminish over time unless reinforced by new input. The decay rate λᵢ is dynamically tuned per trait and session context, enabling adaptive goal mutation and emotional alignment without persistent history or identity.

### Where:

Trait_iₒ is the last computed value,
λᵢ is a signal-specific decay constant tuned dynamically by RecallIQ,
t is the time elapsed since last reinforcement.

Decay constants are context-sensitive. For example, λ for temperature may decay faster in mobile contexts to reflect short attention spans, while viscosity may decay more slowly in kiosk or signage contexts to preserve frictional memory.

### Device-Level Signal Mapping

Traits are derived from input signals that are observable across a variety of interfaces and devices. These signals are processed locally or on the edge to preserve privacy.

| Trait | Primary Signals |
|---|---|
| Temperature | Tap velocity, scroll bursts, gesture intensity |
| Viscosity | Session idle time, CTA avoidance, gesture hesitation |
| Texture | Scroll loops, interface reversals, gesture jitter |
| Density | Unique action count ÷ session duration, multi-modal interaction |
| Confidence | Revisit loops, hover + re-hover patterns, engagement velocity |
| Friction Index | Rage clicks, undo events, reversal clusters |

All calculations are updated per signal event and asynchronously decayed on a timed interval using weighted delta thresholds.

### Use in Personalization Stack

Trait values are continuously emitted to the rest of the engine stack as part of the session's Emotional Trait State. This state is used to:
Drive tone selection (MomentIQ)
Determine offer viability and fallback paths (AffordIQ)
Suppress or trigger rewards (BonusIQ)
Trigger or reverse goal mutations (IntentIQ)
Train learning models (RecallIQ)

For example:
High viscosity+low temperature→trigger Reassure tone and delay CTA
High texture+friction→trigger Educate goal and defer reward
Density spike+confidence drop→mutate goal from Convert to Delay

### Visualization & Explainability Support

Trait values can optionally be visualized in the Vectra rendering layer:
Temperature→inner glow intensity
Viscosity→deformation drag and motion latency
Texture→surface ripple or pulse patterns
Density→motion clustering or trail density
Confidence→rotation velocity or glow synchronization

These visualizations may also be paired with session-local explanation tokens for auditability and transparency, without storing identity or persistent history.

This trait engine forms the emotional physics substrate of the XyloIQ platform-enabling modular, real-time personalization that is fluid, adaptive, and entirely privacy-safe. It provides a mathematically grounded and deployable foundation for interpreting behavioral input as emotionally meaningful output across any device or interaction surface.

### DETAILED DESCRIPTION OF PREFERRED EMBODIMENT

To further support enablement and emotional fidelity, trait decay and signal modulation may be mathematically represented using exponential decay functions. For example, the value of a given Vectra trait T(t) at time t may be calculated using the following expression:

$$T ( t ) = {T}_{0} \cdot e \hat{} ( - λ t )$$

### Where:

T₀ is the initial trait value,
λ is the decay rate constant,
t is the elapsed time since last reinforcing input.

A trait mutation or instability trigger may be activated when:

$$\vert Δ T / Δ t \vert > θ$$

### Where:

ΔT/Δt is the observed rate of change in the trait,
θ is a mutation threshold specific to that trait or attractor class.

This decay-based modeling supports adaptive personalization and goal mutation while maintaining zero-ID compliance.

### DETAILED DESCRIPTION OF PREFERRED EMBODIMENT

The preferred embodiment of the invention comprises a modular, privacy-compliant, real-time personalization engine stack known as XyloIQ. This system interprets live behavioral, environmental, emotional, and economic signals to adapt digital experiences at the tone, content, offer, and engagement levels—without using identity, cookies, or persistent tracking.

The system operates by modeling each session as a deformable emotional object called a Vectra. Each Vectra evolves through time, influenced by live input signals, internal trait decay, and external environmental warp conditions. The Vectra is not static; it deforms in shape, trajectory, and tone based on user interaction and contextual feedback.

### Emotional Goal Attractors Registry

The system maintains a registry of predefined emotional goal attractors, each associated with a gravitational tone profile and behavioral alignment signature. These attractors influence Vectra trajectory and engagement logic within the Vectraverse. While goal attractors may be dynamically inferred, mutated, or reversed based on live emotional trait inputs, the following non-limiting set illustrates the diversity of supported emotional outcomes. Each attractor represents a strategic orientation point for the session and informs tone, pacing, content delivery, and incentive exposure.

### Illustrative Attractor Set:

1. Convert
2. Reassure
3. Delay
4. Educate
5. Celebrate
6. Mirror
7. Escalate
8. Anchor
9. Explore
10. Disarm
11. Abandon
12. Observe
13. Validate
14. Calm
15. Clarify
16. Entertain
17. Motivate
18. Distract
19. Soothe
20. Surprise
21. Challenge
22. Protect
23. Invite
24. Contain
25. Empower
26. Acknowledge
27. Reframe

Goal attractors may be selectively enabled, suppressed, or weighted differently across surfaces, environments, and use cases. Their gravitational influence is recalculated in real time based on Vectra trait state, contextual field warping, and historical mutation resonance scores as computed by RecallIQ.

### Core Architecture

The system comprises adaptive engines:

### IntentIQ—Goal Mutation and Reclassification Engine

### Overview:

IntentIQ is the core real-time inference module responsible for determining a user's engagement goal based on in-session behavior, and mutating that goal as confidence decays, volatility increases, or context shifts. Unlike static intent models, IntentIQ performs continuous goal scoring, confidence decay analysis, and mutation suppression or reversal based on trait deltas and reinforcement signals. It operates without persistent identity, relying solely on live telemetry and contextual metadata.

### Input Signals Used by IntentIQ

Scroll velocity and pattern
Tap cadence, hold duration, gesture confidence
CTA engagement (click-through, avoidance, abandonment)
Dwell time on pricing, policy, or form elements
Navigation behavior (revisit loops, backtrack frequency)
Referrer source (e.g., ad, organic, affiliate)
Environmental context (noise level, device, time of day)
Trait values: temperature, viscosity, friction index (from VectraIQ)
Reversal eligibility flags (from RecallIQ)
Goal mutation history (optional)

### Goal Confidence Model

Each possible goal Gj∈{Convert,Delay,Educate,Reassure, Abandon}G_j\in\{Convert, Delay, Educate, Reassure, Abandon\}Gj∈{Convert,Delay,Educate,Reassure,Abandon} is scored based on alignment with current interaction signals. IntentIQ maintains a Confidence Score (CS) for the active goal, which decays over time in the absence of reinforcement.

### Confidence Score:

$$CS ( t ) = {\sum }_{i = 1}^{n} {W}_{i} \cdot {S}_{i} \cdot {e}^{- {λ}_{i} \cdot ( t - {t}_{i} )}$$

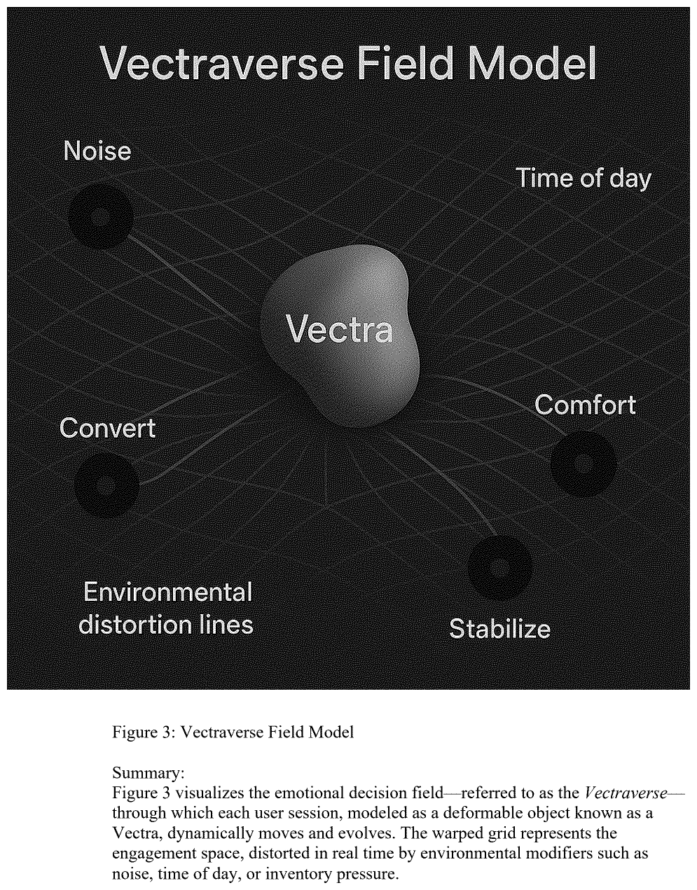

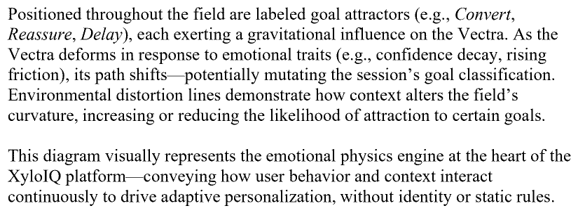

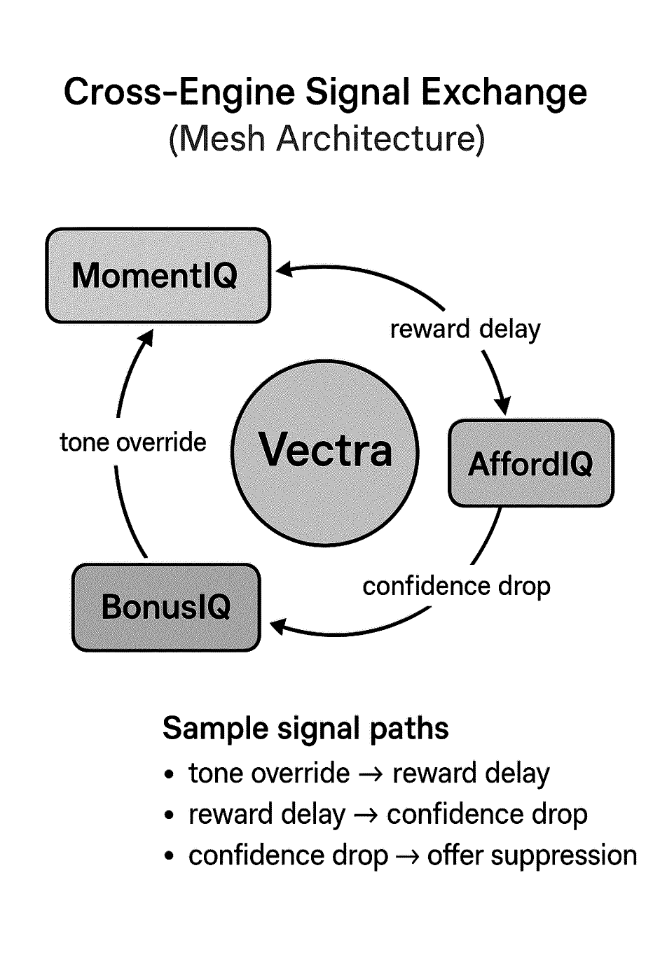

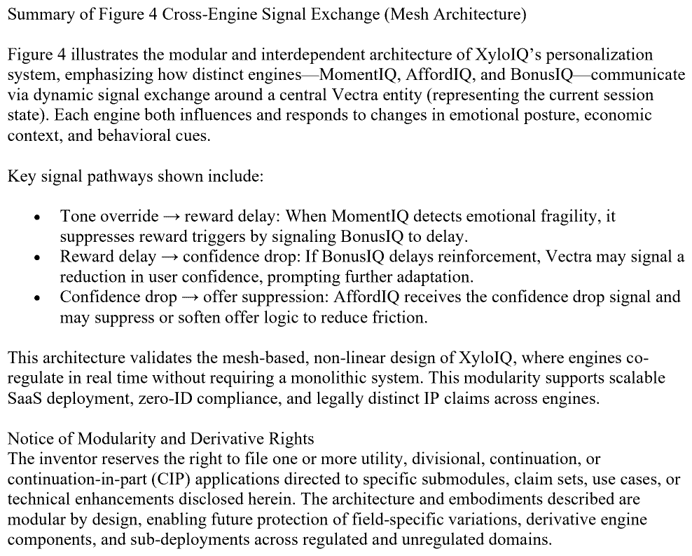

FIG. 4: Goal Confidence Score (CS) Formula—This formula calculates the real-time confidence score for a given engagement goal based on a weighted, time-decayed sum of behavioral signals. Each input signal SiS_iSi is weighted by its importance WiW_iWi, and decays according to its signal-specific rate λi\lambda_iλi over time since its last observation tit_iti. This confidence score determines when a session should trigger a goal mutation or reversal.

### Where:

WiW_iWi=weight of signal i
SiS_iSi=strength of signal i
tit_iti=last observed timestamp of signal i
λi\lambda_iλi=signal-specific decay constant
ttt=current time

This score reflects the decaying alignment of behavior with the current goal.

### Mutation Trigger Logic

### Mutation Trigger Logic

A goal mutation is triggered if:

$$CS ( t ) < {θ}_{mutation}$$

$$AND$$

$$EMRS ( t ) > {θ}_{urgency}$$

### Where:

θₘᵤₜₐₜᵢₒₙ=adaptive mutation threshold
EMRS(t)=Emotional Mutation Readiness Score, derived from Vectra traits:

$$EMRS ( t ) = α \cdot Viscosity + β \cdot Friction + γ \cdot Texture$$

Weights α, β, γ are context-tuned. This composite score reflects readiness to shift engagement strategies based on emotional instability.

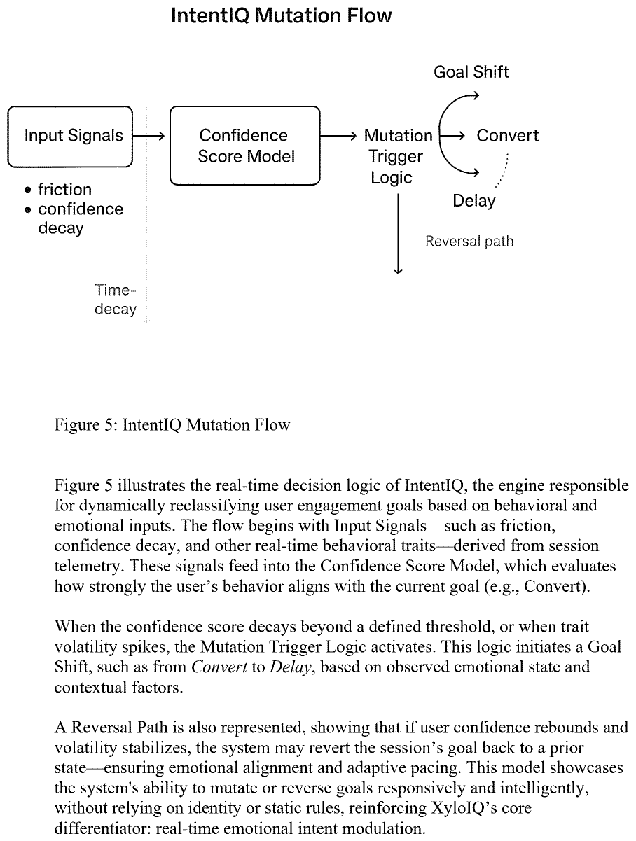

FIG. 5: Mutation Trigger Logic and Emotional Readiness Model—A goal mutation is triggered when the current goal's Confidence Score CS(t)CS(t)CS(t) falls below an adaptive threshold θmutation\theta_{mutation}θmutation, and the Emotional Mutation Readiness Score EMRS(t)EMRS(t)EMRS(t) exceeds an urgency threshold. EMRS(t)EMRS(t)EMRS(t) is calculated using a weighted sum of Viscosity, Friction, and Texture traits-representing the system's detection of emotional instability sufficient to justify strategic redirection (e.g., Convert→Reassure).

### Mutation Decision Model

When a mutation is triggered, the system calculates the most likely next goal:

$${NextGoal}_{j} = arg {max}_{j} ( {W}_{gj} \cdot {F}_{gj} \cdot {H}_{gj} )$$

### Where:

W_{gj}=priority weight of goal j
F_{gj}=feature match (alignment score between signals and goal))
H_{gj}=historical performance of goal j (from RecallIQ)

FIG. 6: Goal Selection Optimization Formula—This equation selects the most appropriate next goal state (NextGoaljNextGoal_jNextGoalj) by maximizing a weighted product of three factors: WgjW_{gj}Wgj (the priority weight of each goal), FgjF_{gj}Fgj (the real-time feature alignment between observed session signals and goal jjj), and HgjH_{gj}Hgj (the historical success rate of goal jjj, as learned by RecallIQ). This ensures that each goal mutation is both emotionally appropriate and performance-informed.

This ensures goal reclassification is both emotionally and strategically optimized.

### Goal Reversal Logic

If CS for the prior goal rebounds above a reversal threshold θrebound\theta_{rebound}θrebound, and emotional volatility decreases:
IntentIQ reverts the goal
Tone and reward logic are soft-ramped via MomentIQ and BonusIQ
   Reversal condition:

$${CS}_{prior} ( t ) > {θ}_{rebound} AND ΔViscosity < 0 AND ΔFriction < 0$$

FIG. 7: Goal Reversal Eligibility Formula—This logic determines when a previously mutated goal (e.g., from Convert→Reassure) can be reversed. A reversal is triggered if: the confidence score for the prior goal CSprior(t)CS_{prior}(t)CSprior(t) rebounds above the reversal threshold θrebound\theta_{rebound}θrebound, and both viscosity and friction exhibit decreasing trends. This ensures that tone escalation or CTA reactivation occurs only after emotional stability returns.

### Decoy Mutation Suppression

IntentIQ uses mutation-risk scoring to detect adversarial patterns (e.g., gesture spam, hesitation loops). If decoy manipulation is suspected:
Mutation is throttled or disabled
BonusIQ is suppressed
RecallIQ is notified for reinforcement pattern tuning

### Outputs Generated by IntentIQ

Current goal classification (e.g., “Convert”, “Delay”)
Confidence score vector
Mutated-from and mutation-to labels
Mutation rationale and EMRS value
Reversal eligibility and volatility trend
Session goal token (shared with other engines)

This logic allows IntentIQ to operate as the strategic core of the XyloIQ system, determining in real time not only what the user is likely trying to achieve—but whether the system should continue pursuing that goal or pivot to a more emotionally or contextually appropriate one.

### MomentIQ—Tone and Timing Orchestration Engine

### Overview:

MomentIQ is the real-time tone, pacing, and message delivery engine within the XyloIQ system. It determines how, when, and in what emotional tone interventions—such as calls-to-action, content modules, reward prompts, or offers—are presented to the user. MomentIQ operates continuously in-session, analyzing a combination of behavioral signals, environmental inputs, emotional traits (from VectraIQ), and goal state metadata (from IntentIQ) to compute and execute personalized output logic.

Unlike static tone templates or pre-set delay timers, MomentIQ dynamically adjusts content tone, delivery format, and sequencing timing in response to emotional volatility, mutation events, friction escalation, recovery pacing, and contextual constraints (e.g., time, noise, inventory urgency)

### Inputs to MomentIQ

Session traits from VectraIQ: temperature, viscosity, texture, density, friction index
Session goal state from IntentIQ: current goal, confidence score, mutation/reversal flags
Environmental signals: time of day, ambient noise, device type, location context
Engagement rhythm: idle time, micro-hesitation patterns, scroll and tap speed variance
Inventory signals (optional): urgency, scarcity, EIS score (via AffordIQ)
BonusIQ readiness: eligibility or suppression flags for gamified interventions

### Tone Classification Logic

MomentIQ computes a Tone Activation Score (TAS) to determine which tone style to apply. Tone selection is based on a mapping between behavioral/emotional posture and delivery style.

### Available Tone Modes:

Assertive
Reassuring
Minimalist
Friendly
Silent
Educator

Each tone mode has a defined range for compatibility with active session states.

### Tone and Timing Orchestration Engine

### Expanded Tone Activation Score (TAS) Formula:

MomentIQ determines the optimal tone for a given interaction window using a weighted trait formula:

$${TAS}_{k} = {\sum }_{i = 1}^{n} {W}_{ki} \cdot {T}_{i}$$

### Where:

TASₖ=Tone Activation Score for tone class k
Tᵢ=value of trait i (e.g., temperature, viscosity)
Wₖᵢ=weight of trait i for tone type k

### Tone Activation Thresholds (Example):

Assertive: TAS>0.85

Reassuring: TAS>0.70 and temperature<0.5

Minimalist: TAS>0.60 and viscosity>0.75

FIG. 8: Tone Activation Score (TAS) Model—This formula calculates the Tone Activation Score TASkTAS_kTASk for a given tone class kkk (e.g., Assertive, Reassuring, Minimalist) by summing weighted emotional trait values. Each trait TiT_iTi (like temperature or viscosity) is multiplied by its corresponding tone-specific weight WkiW_{ki}Wki. The resulting score determines which tone is emotionally appropriate for the session, with threshold examples guiding tone selection based on user state.

### Example:

Given a Session with the Following Traits:
Temperature=0.3
Viscosity=0.8
Friction=0.6
Confidence=0.55

### Using Reassuring Tone Weights:

Wₜₑₘₚ==−0.6
W_{visc}=0.9
W_{friction}=0.7
W_{conf}=0.5

### Then:

$$T A {S}_{Reassure} = ( − 0.6 ) ( 0.3 ) + ( 0.9 ) ( 0.8 ) + ( 0.7 ) ( 0.6 ) + ( 0.5 ) ( 0.55 ) = − 0.18 + 0.72 + 0.42 + 0.275 = 1.235$$

### Result: Tone=Reassuring (Eligible)

FIG. 9: Tone Activation Score Example—Reassuring Mode—This worked example illustrates how the Tone Activation Score TASReassureTAS_{Reassure}TASReassure is computed using trait values (e.g., temperature=0.3, viscosity=0.8) and their corresponding Reassuring tone weights. The result, 1.235, exceeds the eligibility threshold for activating the Reassuring tone, confirming emotional alignment for gentle pacing and softened messaging in-session.

### Expanded Message Timing Score (MTS) Formula:

### MomentIQ Calculates MTS to Determine Message Delivery Timing:

$$MTS = α \cdot IdleTime + β \cdot ScrollFatigue + γ \cdot InteractionDecay$$

### Where:

IdleTime=seconds since last user action
ScrollFatigue=downward trend in scroll velocity
InteractionDecay=time-weighted drop in signal volume

### Example Weights:

α=0.5, β=0.3, γ=0.2
IdleTime=6.0 seconds
ScrollFatigue=0.9 (normalized)
InteractionDecay=0.7

### Then:

$$MTS = 0.5 \cdot 6. + 0.3 \cdot 0.9 + 0.2 \cdot 0.7 = 3. + 0.27 + 0.14 = 3.41$$

If θ_{trigger}=3.0, the message is shown.

FIG. 10: Expanded Message Timing Score (MTS) Calculation—This example shows how MomentIQ computes the Message Timing Score (MTS) to determine when a message should be delivered. The formula weighs three behavioral inputs: IdleTime, ScrollFatigue, and InteractionDecay. With the example values and weights provided, the resulting score (3.41) exceeds the threshold θtrigger=3.0\theta_{trigger}=3.0θtrigger=3.0, authorizing timely message presentation while respecting emotional pacing.

### Micro-Hesitation Index (MHI) Formula:

$$M H I = \frac{TapHolds + GestureStalls + ScrollJitters}{TotalInteractions}$$

### Example:

TapHolds=3
GestureStalls=2
ScrollJitters=4
TotalInteractions=26

$$M H I = \frac{3 + 2 + 4}{25} = \frac{9}{25} = 0.36$$

If MHI>0.30, tone is softened and CTA is delayed.

FIG. 11: Micro-Hesitation Index (MHI) Formula and Example—The Micro-Hesitation Index quantifies subtle signs of user hesitation—such as Tap Holds, Gesture Stalls, and Scroll Jitters—normalized by total interactions. In this example, an MHI of 0.36 exceeds the softening threshold of 0.30, prompting MomentIQ to reduce tone intensity and delay call-to-action (CTA) exposure for emotional alignment and user comfort.

### Tone Ramp Logic (Reversal Scenario):

When a session goal reverses from “Reassure”→“Convert”, MomentIQ initiates soft-ramp logic:
Step 1: Re-enable urgency elements only after viscosity<0.5
Step 2: Gradually animate CTA into view
Step 3: Delay full offer exposure until confidence≥0.6

### Tone Activation Score:

### Tone Activation Score:

$$T A {S}_{k} = {\sum }_{i = 1}^{n} {W}_{ki} \cdot {T}_{i}$$

### Where:

TASₖ=activation score for tone type k
Wₖᵢ=tone sensitivity weight for trait Tᵢ (e.g., viscosity, friction)
Tᵢ=current trait value from VectralQ

### Example:

### For “Reassuring” Tone:

W_{viscosity}=0.8
Wₜₑₘₚₑᵣₐₜᵤᵣₑ=−0.4
W_{friction}=0.9

Tone is selected where TASₖ exceeds the tone activation threshold θₖ, and is compatible with the current session goal.

FIG. 12: Tone Activation Score (TAS)—Trait Weighting and Example—This figure explains how the Tone Activation Score TASkTAS_kTASk is calculated using tone-specific weights WkiW_{ki}Wki applied to current Vectra trait values TiT_iTi. In the example, the “Reassuring” tone is evaluated using weights for viscosity, temperature, and friction. If TASkTAS_kTASk exceeds its tone class threshold θk\theta_kθk, and aligns with the session's goal state, the corresponding tone is activated to ensure emotional congruence.

### Timing and Delivery Logic

MomentIQ determines Message Timing Score (MTS) to decide when to trigger a given intervention. This avoids interruptions during recovery, drift, or volatility spikes.

### Message Timing Score:

### Message Timing Score:

$$MTS = α \cdot IdleTime + β \cdot ScrollFatigue + γ \cdot EngagementPlateau$$

### Where:

IdleTime=seconds since last user action
ScrollFatigue=detected decline in scroll velocity
EngagementPlateau=reduced interaction variety over time

If MTS>θ_{trigger}, MomentIQ authorizes delivery of the next eligible message, but tone and modality are constrained by TAS output and current mutation label.

FIG. 13: Message Timing Score (MTS) Formula—This version of the MTS formula enables MomentIQ to determine when a message should be delivered by evaluating three behavioral indicators: IdleTime, ScrollFatigue, and EngagementPlateau. If the computed score exceeds the threshold θtrigger\theta_{trigger}θtrigger, the system initiates message delivery—while tone and modality remain governed by the active tone classification and current goal mutation label, ensuring emotional and contextual alignment.

### Mutation-Aware Tone Override

When a goal mutation is triggered by IntentIQ, MomentIQ executes a tone override sequence to ensure emotional congruence.

### Example Mutation Handling:

“Convert”→“Reassure”
   →Override any “Assertive” tone
   →Activate “Soft” or “Minimalist” mode
   →Delay CTA visibility
   →Suppress BonusIQ if emotional volatility is high
“Reassure”→“Convert” (reversal)
   →Apply Soft-Ramp Logic:
   Gradually increase urgency, animation intensity, and CTA tone based on emotional stabilization trend.

### Micro-Hesitation Index (MHI)

MomentIQ optionally includes a Micro-Hesitation Index to adjust intervention friction or suppress output when emotional instability is detected in subtle patterns.

$$M H I = \frac{TapHolds + GesturePauses + ScrollJitters}{InteractionCount}$$

FIG. 14: Alternate Micro-Hesitation Index (MHI) Formula—This variation of the MHI formula calculates subtle user hesitation by combining Tap Holds, Gesture Pauses, and Scroll Jitters, normalized by the total number of interactions. A higher MHI indicates emotional instability or cognitive friction, triggering tone softening and CTA delay to maintain emotional alignment during uncertain moments.

If MHI exceeds an emotional volatility threshold, the tone is softened or suppressed and BonusIQ is paused until recovery.

### Visual and Delivery Modality Coordination

### MomentIQ Selects the Optimal Delivery Format:

Modal banner
Tooltip
Animated nudge
Voice prompt (in voice environments)
Pop-up tile
Scroll-embedded callout

Delivery format is matched to tone and emotional posture. For example:
High viscosity+high friction→tooltip with soft animation
Low viscosity+“Convert”→assertive pop-up with urgency prompt
   Outputs from MomentIQ
Selected tone classification (e.g., “Reassuring”, “Minimalist”)
Message timing delay (in ms)
Suppression flag for CTA or BonusIQ
Selected delivery format (e.g., tooltip, modal)
Tone override label (used by UI rendering engine)
Optional explanation token (e.g., “Tone softened due to hesitation loop”)

### Cross-Engine Synchronization

IntentIQ provides mutation label and goal reversal signals
BonusIQ receives suppression flags and tone gating inputs
AffordIQ receives tone multiplier (e.g., to soften offer copy)
RecallIQ logs tone path and response success for reinforcement learning

All state changes and outputs are optionally logged to the Compliance Token Layer (CTL) for explainability, auditability, and override inspection.

### Fallback and Edge Logic

In environments with limited connectivity (e.g., kiosk, automotive), MomentIQ operates using:
Cached tone rules and context thresholds
Precompiled tone-goal compatibility matrices
Fixed decay-based delays for fallback pacing
Local suppression of urgent CTA logic during mutation

Tone override states are synchronized post-session for recall training.

### SUMMARY

MomentIQ is the emotional control layer of the XyloIQ system. It ensures that what the system chooses to present (via IntentIQ and AffordIQ) is delivered in a manner that is emotionally aligned, contextually relevant, and recovery-aware. It uses a combination of scalar modeling, mutation-awareness, and pacing logic to produce outputs that feel natural and trustworthy, even as session goals shift midstream.

### AffordIQ—Offer Logic and Economic Framing Engine

### Overview:

AffordIQ is a session-based offer strategy engine that determines which pricing logic, incentive structure, and economic framing should be applied to a user in real time-without relying on identity, cookies, CRM profiles, or stored history. It evaluates the user's inferred price sensitivity and session economics using a computed Affordability Index (AI) and an optional Economic Impact Score (EIS) to balance personalization relevance with business constraints such as inventory, margin, or promotion policy.

AffordIQ operates in coordination with IntentIQ, MomentIQ, and BonusIQ. When a session goal mutates (e.g., from “Convert” to “Delay” or “Reassure”), AffordIQ adjusts offer timing, urgency, type, and emotional framing accordingly.

### Inputs to AffordIQ

Behavioral signals:
   Price filter usage (e.g., “low to high” sort)
   Coupon hover or abandonment
   Dwell time on high-vs. low-priced items
   Tap stall near checkout
   Scroll-back near price or terms
Environmental signals:
   Device type (e.g., mobile=budget bias)
   Time of day (e.g., payday, nighttime)
   Inventory state (e.g., low stock, expiring product)
Emotional state:
   Vectra traits (viscosity, temperature, friction)
   Current goal classification (from IntentIQ)
BonusIQ exposure history
Prior goal mutations (e.g., “Convert”→“Reassure”)

### Affordability Index (AI) Formula

AffordIQ computes a real-time Affordability Index (AI) using a weighted scoring model that reflects price sensitivity and value-seeking behavior.

$$AI = {\sum }_{i = 1}^{n} {W}_{i} \cdot {S}_{i}$$

Where:
AI∈[0.00, 1.50]
Wᵢ=weight of signal i
Sᵢ=normalized value of signal i

### Example Input Signals:

| Signal | Sᵢ | Weight Wᵢ |
|---|---|---|
| Price filter used (“Low to High”) | 1.0 | 0.25 |
| Coupon hover but not applied | 0.8 | 0.40 |
| High-priced item exit | 1.0 | 0.60 |
| Cart abandonment | 1.0 | 0.75 |

$$AI = ( 0.25 \cdot 1. ) + ( 0.4 \cdot 0.8 ) + ( 0.6 \cdot 1. ) + ( 0.75 \cdot 1. ) = 0.25 + 0.32 + 0.6 + 0.75 + 1.92$$

AI is capped at 1.50. Thus:

FIG. 15: Affordability Index (AI) Calculation and Example—This formula computes the Affordability Index (AI) as a weighted sum of normalized economic behavior signals, such as price filter use, coupon interaction, and cart abandonment. The resulting score reflects inferred price sensitivity within the session. In this example, the raw AI exceeds the 1.50 cap, which ensures consistent scaling. AffordIQ uses this index to adjust offer framing, delay promotions, or trigger payment flexibility logic—all without using identity or stored history.

$$AI = min ( 1.92 , 1.5 ) = 1.5$$

### Interpretation:

AI<0.7: High price sensitivity
AI 0.7-1.0: Moderate sensitivity
AI>1.0: Premium potential or economic confidence

### Expanded Economic Impact Score (EIS) Formula

The EIS models whether the proposed offer is viable based on margin, urgency, and alignment with system goals.

$$E I S = α \cdot GM - β \cdot IC + γ \cdot GA$$

### Where:

GM=Gross Margin of the product (0.0-1.0)
IC=Inventory Carrying Cost (0.0-1.0)
GA=Goal Alignment Modifier
α, β, γ=weights (default: 1.0, 0.5, 0.75)

FIG. 16: Affordability Index (AI) and Economic Impact Score (EIS) Formulas—The top section interprets AI scores to classify user price sensitivity (e.g., AI>1.0 implies premium readiness). The bottom section introduces the Economic Impact Score (EIS), which evaluates whether an offer is viable based on gross margin (GM), inventory cost (IC), and goal alignment (GA). AffordIQ uses EIS in tandem with AI to govern offer exposure, promotional timing, and reward eligibility—all while maintaining session-local decisioning.

### Example Values:

GM=0.60 (60% margin)
IC=0.40 (moderate inventory pressure)·
GA: 1.0 if goal=Convert; 0.6 if Delay; 0.0 if Abandon

### For Convert Goal:

$$E I S = ( 1. \cdot 0.6 ) - ( 0.5 \cdot 0.4 ) + ( 0.75 \cdot 1. ) = 0.6 - 0.2 + 0.75 = 1.15$$

### Thresholds:

EIS≥1.0→Allow offer
EIS<1.0→Delay, degrade, or suppress

FIG. 17: Economic Impact Score (BIS) Example Calculation—This worked example demonstrates how EIS is computed using real-time session context: product margin (GM), inventory cost (IC), and goal alignment (GA). For a Convert goal, the resulting EIS of 1.15 exceeds the 1.0 threshold, signaling that the offer is viable and should be shown. Lower EIS scores would prompt offer suppression, degradation, or delay based on emotional and economic posture.

### Offer Delay Function

To avoid delivering offers too early (especially post-mutation), AffordIQ applies a delay score:

$$OffDelay = {θ}_{base} + δ \cdot V + ϵ \cdot F$$

### Where:

θ_{base}=base delay (e.g., 2000 ms)
V=Viscosity (0-1)
F: Friction Index (0-1)
δ, ϵ=trait weighting constants

### Example:

Viscosity=0.85
Friction index=0.70
θ_{base}=2000, δ=2000, ϵ=1500

$$OfferDelay = 2000 + ( 2000 \cdot 0.85 ) + ( 1500 \cdot 0.7 ) = 2000 + 1700 + 1050 = 4750 ms$$

Interpretation: AffordIQ delays offer exposure for ˜4.75 seconds to allow emotional stabilization before presenting CTA.

FIG. 18: Offer Delay Function Based on Emotional Traits—This formula calculates a personalized delay before showing an offer, using Viscosity and Friction Index to assess emotional readiness. Post-mutation sessions may require emotional stabilization before CTA exposure. In this example, AffordIQ computes a total delay of 4750 ms based on high viscosity and friction, ensuring tone and timing are appropriate to user state and maximizing engagement without rushing the decision moment.

### Recovery Offer Pathways

AffordIQ includes a 3-tier fallback flow when economic or emotional state does not support conversion:
1. Primary: Installment offer or time-limited incentive
2. Secondary: Framing fallback (“Try now, cancel anytime”)
3. Tertiary: Passive retention (“Want to hold this offer?”)

### Selection is Governed by:

Low AI→prioritize symbolic or long-term incentives
High viscosity+friction→suppress tiers 1 and 2
Low EIS→restrict monetary offers, offer loyalty points

### Affordability Index (AI)

AffordIQ calculates a real-time Affordability Index, a unitless score that quantifies inferred economic sensitivity on a scale from 0.00 to 1.50.

### Example Signal Weights:

Price filter used: 0.25
Coupon clicked: 0.40
High-priced item bounce: 0.60
Cart abandonment: 0.75

A lower AI (<0.7) suggests high price sensitivity; higher AI (>1.0) suggests flexibility or premium readiness.

### Economic Impact Score (EIS)

AffordIQ uses a second score to model offer viability from the platform's perspective:

### Formula:

$$EIS = α \cdot GM - β \cdot IC + γ \cdot GA$$

### Where:

GM=Gross Margin of the item or bundle
IC=Inventory Carrying Cost
GA=Goal Alignment Multiplier (e.g., “Convert”=1.0, “Delay”=0.6)
α, β, γ=configurable business weights

The EIS determines whether an offer should be promoted, suppressed, delayed, or soft-framed.

FIG. 19: Economic Impact Score (BIS) Formula—Business-Aligned Offer Viability—This version of the EIS equation determines whether an offer should be promoted, suppressed, delayed, or reframed by weighing product margin (GM), inventory carrying cost (IC), and goal alignment (GA). The tunable weights α,β,γ\alpha, \beta, \gammaα,β,γ allow enterprises to prioritize profitability, inventory pressure, and strategic goal targeting in real time, all without requiring user identity or stored history.

### Mutation-Aware Offer Framing

When the current session goal has been mutated (via IntentIQ), AffordIQ adjusts offer strategy to ensure emotional and contextual alignment:
Goal Offer Strategy
Convert Assertive CTA, urgency tones, full offer
Reassure Delay CTA, soften framing, emphasize “no risk”
Delay Offer save-for-later or reminder logic
Educate Trigger comparison chart, trial, or explainer module Abandon Suppress offer exposure, optionally flag for retargeting

### Offer Timing Logic

AffordIQ uses a delay function to gate when an offer is shown based on volatility and engagement stability.

### Delay Function:

$$OfferDelay = {θ}_{base} + δ \cdot Viscosity + ϵ \cdot FrictionIndex$$

### Where:

θ_{base}=baseline wait time (ms)
δ, ϵ=trait-to-delay tuning weights

If volatility is high, offer may be delayed or blocked entirely.

FIG. 20: Offer Delay Function with Volatility-Sensitive Logic—This version of the AffordIQ offer delay model calculates how long the system should wait before showing an offer based on the user's emotional state. Viscosity and Friction Index are combined using tuning weights δ\deltaδ and ϵ\epsilonϵ, added to a base wait time θbase\theta_{base}θbase. If volatility is detected to be high, the system may further delay or block the offer entirely to prevent emotional mismatch or user overwhelm.

### Objection Sequencing and Recovery Offers

AffordIQ includes a 3-stage fallback system when pricing friction or goal mutation occurs:
1. Primary Offer: Installment or timed incentive
2. Secondary: Value frame (e.g., “Hold this offer,” “Try now, cancel anytime”)
3. Tertiary: Exit mitigation or lightweight “exploration bonus”

The system selects the lowest-risk eligible tier based on AI, EIS, and emotional readiness.

### Example Adaptations by Goal

### Mutation: Convert→Reassure

Suppress countdown timers
Present refundable framing: “Try risk-free”
Apply delayed CTA exposure

### Mutation: Convert→Delay

Offer “Save this offer” or email prompt
Remove urgency cues
Suppress BonusIQ unless EIS>threshold

### Reversal: Reassure→Convert

Apply soft-ramp tone logic.
Restore assertive offer flow after tone recovery window
   Outputs from AffordIQ
Selected offer type (bundle, discount, trial, deferral)
Offer framing tone (assertive, soft, minimalist)
Offer delivery timing (immediate, delayed, suppressed)
BonusIQ reward eligibility signal
Economic suppression flag (for margin control)
Mutation-aware CTA script (e.g., “Explore Options” vs. “Buy Now”)

### Cross-Engine Coordination

IntentIQ: Provides current goal and mutation path
MomentIQ: Supplies tone framing or suppression signal
BonusIQ: Receives reward enable/disable signal based on EIS and AI
RecallIQ: Learns offer outcomes and adjusts AI threshold mapping

All outputs and adjustments are logged to the Compliance Token Layer (CTL), with reason codes (e.g., “Offer deferred due to emotional recovery state”).

### Fallback and Edge Mode Support

On limited-connectivity surfaces (e.g., kiosks, vending), AffordIQ operates using:
Precompiled AI/EIS scoring templates
Local tone-goal pairing rules
Deferred incentive bundles for delayed reward delivery
EIS gating for offline-safe offer logic

All logic is evaluated session-locally and synchronized post-connection.

### SUMMARY

AffordIQ ensures that all offers are:
Emotionally intelligent (via trait-state coordination)
Economically justified (via EIS logic)
Privacy-safe and session-local (no identity required)

It dynamically balances empathy, personalization, and business value—adapting offers in real time based on both user behavior and enterprise constraints.

### RecallIQ—Anonymous Reinforcement Learning and Outcome Optimization Engine

### Overview:

RecallIQ is the adaptive learning core of the XyloIQ engine stack. It continuously refines personalization strategies—such as goal mutation thresholds, tone modulation sensitivity, reward timing, and offer selection—based entirely on anonymous, in-session outcomes. It does not rely on persistent user profiles, device identity, or session linkage. All learning is performed in a privacy-safe, explainable manner and is compatible with federated edge learning deployments.

RecallIQ operates using a reinforcement learning (RL) framework, where system actions (e.g., mutating a goal, showing a reward, escalating tone) are treated as decisions, and user responses are scored to reinforce or penalize future actions. The engine optimizes mutation logic, confidence decay tuning, emotional alignment, and outcome-driven pacing across the entire XyloIQ engine stack.

### RecallIQ—Anonymous Reinforcement Learning and Outcome Optimization Engine

### Overview

RecallIQ is the session-local, identity-free reinforcement learning engine that continuously tunes goal mutation thresholds, tone modulation weights, reward gating behavior, and trait decay dynamics. It does so based entirely on observed outcomes of prior in-session decisions—without ever storing personal history, PII, or persistent profiles.

Learning occurs at two levels:
1. Session-local learning (used in-session only)
2. Federated weight updates (aggregated across devices and environments)

RecallIQ employs a multi-armed bandit framework to optimize decisions based on probabilistic outcomes, leveraging contextual archetype tagging to preserve edge specificity and improve policy generalization.

### Learning Objectives

### RecallIQ's Learning Engine Continuously Optimizes:

Which mutation paths are likely to succeed
Whether to delay or suppress rewards
When to apply soft vs. assertive tone strategies
How fast confidence should decay per user archetype
When goal reversal should be permitted

### Input Signals to RecallIQ

### From IntentIQ:

Goal mutation events (e.g., Convert→Delay)
Confidence scores at mutation time
Trait snapshot (temperature, viscosity, etc.)

From MomentIQ:
Tone classification used
MHI and TAS outcomes

### From BonusIQ:

Reward trigger status
Delay timing
Redemption outcomes

### From AffordIQ:

Offer tier shown
EIS score at time of exposure
Engagement or drop-off

### Session Feedback:

Conversion, abandonment, re-engagement
Exit timing and CTA interactions
Time since goal mutation vs. decision event

### Mutation Path Learning (Bandit Framework)

Each unique goal mutation path is modeled as a decision arm in a bandit loop. Example path:

| | | |
|---|---|---|
| . - . . | . . | |
| [symbol] | [symbol] Copy | [symbol] Edit |
| Convert → Delay → Educate | | |

[symbol]

indicates data missing or illegible when filed

Each arm is scored based on:
Engagement uplift
Reward conversion
Tone adherence
Abandonment mitigation

### Probability of Success:

$${P}_{success} ( {a}_{j} ) = \frac{{α}_{j}}{{α}_{j} + {β}_{j}}$$

### Where:

αⱼ=decision arm (e.g., Convert→Reassure)
αⱼ=# of successful outcomes for arm j
βⱼ=# of failures (non-response, exit, conflict)

This scoring is used to prioritize goal paths and modulate future mutation thresholds.

FIG. 21: Goal Path Scoring and Mutation Success Probability—This formula calculates the probability of success for a given goal transition path (e.g., Convert→Delay→Educate) using the ratio of positive outcomes αj\alpha_jαj to total attempts αj+βj\alpha_j+\beta_jαj+βj. Each goal “arm” is evaluated based on engagement uplift, reward conversion, tone adherence, and abandonment mitigation. RecallIQ uses this scoring to prioritize effective mutation paths and dynamically adjust mutation thresholds for future sessions—without storing user identity or behavioral history.

### Example

### Assume:

Arm: “Convert→Reassure”
α=38, β=12

$${P}_{success} = \frac{38}{38 + 12} = \frac{38}{50} = 0.76$$

### Interpretation:

High-confidence arm
· Used preferentially for high-friction, low-temperature sessions

### Decay and Normalization Logic

To prevent learning drift:
Exponential decay is applied to outdated path scores:

$${α}_{i + 1} = {α}_{t} \cdot {e}^{- λ \cdot Δ t}$$

Volatility cap avoids single-session dominance
Archetype-specific cooling ensures high-performing paths are not overapplied across user types

[symbol]

FIG. 22: Mutation Arm Success Example and Decay Logic—This example computes a 76% success rate for the goal transition “Convert→Reassure,” identifying it as a high-confidence mutation path ideal for high-friction, low-temperature sessions. Below, RecallIQ's decay and normalization logic is shown: outdated scores decay exponentially to prevent overfitting, while volatility caps and archetype-specific cooling avoid single-session dominance or inappropriate generalization—preserving adaptive accuracy without persistent user profiling.

### Trait Decay Tuning (λ Adjustment)

RecallIQ tunes the decay constant λλλ used by the Trait Engine based on observed emotional volatility and outcome history.

### Example:

If users with:
Friction>0.7
Texture>0.8
Convert→Delay path
   . . . have low reward conversion,

Then RecallIQ increases λλλ for confidence decay, resulting in:
Faster goal mutation
Softer tone ramp
BonusIQ suppression

### Federated Learning and Edge Support

On-device training is performed using:
Lightweight reward outcome tracking
Cumulative score delta per arm
No user data retention
Differential privacy applied to weight updates

### Every Edge Node:

Tags session archetypes (e.g., “evening mobile+hesitant CTA”)
Aggregates local results
Sends delta weights (no raw signals) to the central RecallIQ pool

### Outcome Evaluation Example

### Session:

Goal: Convert→Delay
Reward: Suppressed
Offer: Soft-framed
Result: CTA clicked 28 seconds later

### RecallIQ:

Reinforces Convert→Delay for similar trait profiles
Lowers tone intensity for Delay→Convert reversals
Logs engagement curve for that archetype

### Cross-Engine Outputs

### RecallIQ Influences:

IntentIQ: Updates goal mutation thresholds and mutation chain preferences
MomentIQ: Adjusts tone softening pace and escalation delay
AffordIQ: Tunes default offer exposure delay and framing tiers
BonusIQ: Modifies reward suppression thresholds, especially after reversal or re-engagement.
Trait Engine: Modulates decay rates per trait (e.g., λ_temp, λ_viscosity)

Each adjustment is scoped to a session archetype (e.g., “mobile scroll-heavy late-night”) and versioned for auditability.

### Compliance and Transparency Layer

All reinforcement decisions are logged as non-identifying delta events
Compliance Token Layer (CTL) stores:
   Arm pulled
   Outcome value
   Rationale summary
   No behavioral signal history
Data is destroyed after session or normalized into aggregate weights
No IP, cookie, email, or device identifier is stored or required

### SUMMARY

RecallIQ enables real-time, privacy-first reinforcement learning for emotionally responsive engagement. By continually adjusting decay rates, tone policies, mutation probabilities, and reward behaviors based on observed outcomes, it ensures every decision improves-without storing a single user's identity.

It is the backbone of long-term personalization efficacy and the learning brain behind the Vectraverse.

### Inputs to RecallIQ

Mutation events from IntentIQ:
   Original and mutated goal
   Confidence score at time of mutation
   Trait state (e.g., viscosity, texture, density).
Tone decisions from MomentIQ
Offer and EIS framing from AffordIQ
Reward triggers and success/failure from BonusIQ
Conversion signals:
   Click-through
   Purchase/engagement
   Form completion
   Bounce or exit timing
Session archetype classification (e.g., “scroll-heavy mobile at night”)

### Mutation Path Tracking

Each session mutation event is treated as a decision path, and its effectiveness is tracked using a bandit-inspired scoring model. Mutation chains are logged in-session and assigned outcome scores.

### Example Path:

| | | |
|---|---|---|
| sql | [symbol] Copy | [symbol] Edit |
| Convert → Delay → Educate → Reassure | | |

FIG. 23: Multi-Stage Goal Mutation Path—This visual represents a compound emotional trajectory through successive goal states: Convert→Delay→Educate→Reassure. Each stage reflects a real-time emotional posture inferred from trait vectors, with each transition triggered by trait decay, volatility spikes, or contextual pressure. This chained mutation model allows the system to dynamically adapt tone, pacing, and CTA exposure across fluctuating emotional states—all without identity or stored history.

Each transition is scored for:
Immediate engagement improvement
Reward redemption
Conversion uplift
Time-to-exit reduction

RecallIQ assigns outcome scores per path to tune future thresholds and reclassification rules.

### Multi-Armed Bandit Learning Loop

RecallIQ uses a bandit-style reinforcement loop (e.g., Thompson Sampling) to balance exploration and exploitation. Each mutation path, tone variant, or reward structure is treated as an arm.

### Arm Scoring Formula:

$${P}_{success} ( {a}_{i} ) = \frac{{α}_{i}}{{α}_{i} + {β}_{i}}$$

### Where:

αᵢ=action arm (e.g., “Convert→Delay”)
αᵢ=success count
βᵢ=failure count

FIG. 24: Probability of Success for Mutation Arms—This formula from RecallIQ computes the likelihood that a given action path (e.g., Convert→Delay) will succeed, based on observed outcomes. It calculates the probability using the ratio of successful transitions αi\alpha_iαi to total attempts αi+βi\alpha_i+\beta_iαi+βi, enabling adaptive prioritization of emotionally and strategically aligned goal mutations—without identity tracking or profile persistence.

The system pulls higher-confidence arms more often but continues exploring others to improve its model.

### Decay and Cooling Logic

To prevent learning drift or manipulation:
Session-Weighted Decay: Older success patterns fade unless reinforced
Reward Dampening: Overperforming strategies are normalized to prevent overfitting
Mutational Cooling: Excessive mutations in short sessions trigger cooldown
Archetype Diversification: Signals from one session type don't dominate unrelated types

### Confidence Decay Tuning

RecallIQ tunes the decay constant λ\ambdaλ used by IntentIQ based on observed friction patterns and goal reclassification outcomes.

### Example:

If “Convert→Reassure” underperforms when friction is high→RecallIQ reduces mutation frequency by adjusting λ\lambdaλ or raising mutation threshold.

### Federated Learning Support

In edge deployments (e.g., kiosks, signage, POS), RecallIQ operates with on-device learning:
Local success/failure tracking per mutation or reward
Differential privacy aggregation of weight updates
No raw telemetry transmission
Anonymized outcome vectors uploaded periodically to a central model

This enables location-specific tuning (e.g., different reward sensitivity in airports vs. gyms).

### Goal Transition Evaluation Example

For a session where:
Goal mutates: “Convert”→“Delay”
Reward is suppressed
Offer is soft-framed
User later re-engages and completes CTA

RecallIQ logs this outcome and:
Reinforces mutation path as effective
Reduces tone urgency in similar “Convert→Delay” cases
Enables earlier offer timing if high EIS is detected post-mutation

### Cross-Engine Output Adjustments

RecallIQ outputs include:
Updated mutation thresholds (for IntentIQ)
Tone timing deltas (for MomentIQ)
Offer pacing rules (for AffordIQ)
Reward gating values (for
Trait decay tuning (e.g., λ recalibration)

Each output is versioned, timestamped, and scoped to a session archetype (e.g., “evening mobile hesitant user”).

### Compliance and Audit Layer

All RecallIQ learning is:
Session-local during operation
Anonymized before aggregation
Stored only as aggregated model weights
Auditable via the Compliance Token Layer (CTL), which logs:
   Mutation path
   Outcome score
   A/B arm pulled
   Reinforcement value

No identifiable data or raw signal history is retained.

### Fallback and Edge Adaptation

When operating offline:
Local mutation thresholds are used from precompiled profiles
Reward performance tables are cached by context
Upon reconnect, device shares only weight deltas

### Example:

Vending machine observes “Convert→Reassure” mutation results in higher QR scan rate during finals week→RecallIQ on-device reinforces this mutation path until the next sync window.

### SUMMARY

RecallIQ transforms XyloIQ from a reactive experience engine into a proactive learning system. By evaluating mutation outcomes, emotional alignment, tone effectiveness, and reward resonance, it enables every engine to evolve continuously—without identity, cookies, or tracking.

It ensures that every tone, offer, or incentive is not only personalized—but provably effective in its emotional and strategic context.

### BonusIQ—Emotionally-Aligned Reward and Engagement Engine

### Overview:

BonusIQ is a gamified, emotionally adaptive incentive engine designed to reinforce positive behavior, re-engage users after hesitation, and amplify momentum during conversion-readiness states—all while maintaining economic and psychological alignment with the current session state. BonusIQ operates entirely within-session and does not rely on identity, persistent tracking, or reward histories.

BonusIQ determines if, when, and how to deliver rewards such as surprise incentives, spin wheels, unlockables, or loyalty points. It evaluates eligibility based on a combination of emotional readiness, goal state, economic viability, and behavioral rhythm.

BonusIQ ensures rewards are not only effective—but emotionally appropriate, margin-safe, and strategically timed.

### Inputs to BonusIQ

Behavioral Signals
   Idle time duration
   Scroll rhythm and plateaus
   Tap hesitation and CTA avoidance
   Gesture delay or reversal
   Re-engagement after dropout
Emotional State from VectraIQ
   Temperature (arousal)
   Viscosity (resistance)
   Texture (volatility)
   Confidence and friction index
Session Goal from IntentIQ
   Active or mutated goal label
   Mutation path and rationale
   Reversal state (if present)
Tone Context from MomentIQ
   Tone intensity (Assertive, Reassuring, Minimalist)
   Suppression or soft-ramp flags
Offer Context from AffordIQ
   Economic Impact Score (EIS)
   Reward ROI threshold logic
   Inventory availability or gating status
Performance Feedback from RecallIQ
   Reward resonance scores
   Reward fatigue detection
   Outcome-linked reinforcement deltas

### Expanded Reward Readiness Score (RRS) Formula

BonusIQ computes a session-local Reward Readiness Score (RRS) to determine if a reward should be triggered, delayed, or suppressed. This score is derived from emotional traits and behavioral posture.

$$RRS = {θ}_{base} - ( α \cdot V + β \cdot F + γ \cdot T ) + δ \cdot C$$

### Where:

RRS∈[0.00, 2.00]
V=Viscosity
F=Friction Index
T=Texture
C=Confidence
α, β, γ, δ=trait weights (default: 1.2, 1.1, 0.9, 0.8)
θ_{base}=baseline readiness constant (typically 1.0)

FIG. 25: Reward Readiness Score (RRS) Formula—BonusIQ calculates the Reward Readiness Score (RRS) to determine if a session is emotionally eligible for gamified or incentivized reward exposure. RRS balances suppressive traits (Viscosity, Friction, Texture) against positive engagement signals like Confidence. The formula subtracts a weighted suppression sum from a baseline threshold θbase\theta_{base}θbase, ensuring that rewards are only triggered when the user is emotionally ready—thereby avoiding pressure, misalignment, or premature escalation.

### Example:

Session traits:
Viscosity=0.85
Friction=0.75
Texture=0.60
Confidence=0.45

Using weights:

$$α = 1.2 , β = 1.1 , γ = 0.9 , δ = 0.8$$

$$RRS = 1. - ( 1.2 \cdot 0.85 + 1.1 \cdot 0.75 + 0.9 - 0.6 ) + 0.8 \cdot 0.45 = 1. - ( 1.02 + 0.825 + 0.54 ) + 0.36 = 1. - 2.385 + 0.36 = - 1.025$$

Interpretation:
RRS<0.0→Reward is suppressed
RRS between 0.0 and 0.8→Reward is delayed
RRS>0.8→Reward is eligible and triggered

FIG. 26: Reward Readiness Score (RRS) Example Calculation—This example shows how BonusIQ determines reward eligibility based on Vectra traits. With high viscosity, friction, and texture—and low confidence—the computed RRS falls below zero (−1.025), triggering full reward suppression. The logic ensures that rewards are only presented when the user's emotional posture indicates readiness, balancing motivational impact with cognitive safety and ethical engagement.

### Mutation-Aware Reward Adjustments

BonusIQ listens for current goal state and recent mutations from IntentIQ. Reward framing and exposure logic are modified accordingly:

| | |
|---|---|
| Goal | State Reward Behavior |
| Convert | Gamified (spin wheels, countdowns, |
| | unlocks) enabled |
| Delay | Visual delay, passive rewards (e.g., |
| | symbolic tokens) |
| Reassure | Low-stimulation framing; no |
| | animation; delayed trigger |
| Educate | Informational rewards (e.g., |
| | bonus tips, quiz unlock) |
| Goal State | Reward Behavior |
| Abandon | Rewards paused or converted to |
| | “return when ready” message |

BonusIQ also adapts reward value and cadence based on mutation severity, e.g., from Convert→Delay→Reassure, only symbolic rewards may remain available.

Economic Suppression Gating (with EIS)

Before triggering a reward, BonusIQ verifies economic feasibility using AffordIQ's BIS score:
If EIS<1.0.
   Reward is downgraded (e.g., loyalty points instead of a discount)
   Frame shifts to symbolic (“Thank you for exploring”)
If EIS>1.2:
   Full-value reward permitted
   Additional gamification logic activated (e.g., “spin for bonus”)

FIG. 27: Economic Suppression Gating Using EIS—BonusIQ uses the Economic Impact Score (EIS) from AffordIQ to determine if a reward should be delivered at full value, downgraded, or symbolically framed. If EIS<1.0EIS<1.0EIS<1.0, the system may suppress gamification and offer symbolic rewards; if EIS>1.2EIS>1.2EIS>1.2, full-value rewards and enhanced mechanics (like “spin for bonus”) are authorized. This ensures reward logic balances emotional alignment with real-time business feasibility.

### Dynamic Reward Delay Calculation

$$RewardDelay = {θ}_{delay} + λ \cdot Viscosity + μ \cdot MHI$$

### Where:

θ_{delay}=base delay time (e.g., 1000 ms)
MHI: Micro-Hesitation Index (from MomentIQ)
λ, μ=scaling constants (e.g., 2000, 1500)

### Example:

Viscosity=0.80, MHI=0.65

$${θ}_{delay} = 1000 , λ = 2000 , μ = 1500$$

$$RewardDelay = 1000 + ( 2000 \cdot 0.8 ) + ( 1500 \cdot 0.65 ) = 1000 + 1600 + 975 = 3575 ms$$

Reward animation will be delayed by ˜3.6 seconds to match emotional pacing.

FIG. 28: Dynamic Reward Delay Calculation Based on Emotional Traits—This BonusIQ formula delays reward animations in real time based on user hesitation. It incorporates both Viscosity and the Micro-Hesitation Index (MHI), scaled by constants λ\lambdaλ and μ\muμ and added to a base delay θdelay\theta_{delay}θdelay. In this example, the calculated delay is 3575 ms, allowing emotionally sensitive users to stabilize before a gamified or incentive-based element is shown—ensuring alignment between emotional state and timing of reward exposure.

### Reward Tiering and Framing Matrix

| Emotional State | Reward Format | Framing Message |
|---|---|---|
| Low Friction + High Confidence | Instant incentive | “You've earned this!” |
| High Viscosity + Low Confidence | Symbolic message | “We appreciate your time.” |
| Mid Friction + EIS > 1.2 | Interactive gamified | “Try your luck-bonus awaits” |
| Reassure → Convert (Reversal) | Delayed spin | “Here's a small boost to keep going” |

Final Outputs from BonusIQ
reward_eligibility: Boolean
reward_format: Symbolic, Timed, Gamified
delay_ms: Numeric delay for pacing
suppression_reason: e.g., “High viscosity”, “Low EIS”
reward_tone: assertive/soft/hidden
bonus_token: session-local reward metadata (optional)

All reward decisions are:
Logged to the Compliance Token Layer (CTL)
Ephemeral and privacy-preserving
Modifiable via override APIs if permitted

### Mutation-Aware Reward Logic

BonusIQ listens for session goal mutations (via IntentIQ) and adapts reward logic accordingly.

| Goal State | Reward Behavior |
|---|---|
| Convert | Enable gamification (spin, countdown, unlockables) |
| Delay | Suppress active gamification, suggest passive rewards |
| Reassure | Delay or defer reward delivery, use symbolic formats |
| Educate | Use information-based rewards |
| | (e.g., bonus tips, explainer unlocks) |
| Abandon | Hold back rewards, suggest soft re-entry CTAs |

### Reward Types and Formats

BonusIQ supports a configurable library of reward mechanisms:
Spin wheels
Countdown unlocks
Instant scratch-to-reveal cards
QR-scan bonuses (for signage or POS)
Loyalty point drops or digital badges
“Surprise boost” offers post-interaction

All rewards are framed to match the user's emotional tone, pacing, and economic context.

### Economic Impact Gating

To ensure business alignment, BonusIQ evaluates the Economic Impact Score (EIS) from AffordIQ before releasing any reward. If EIS is below threshold:
Reward is downgraded (e.g., points instead of cash incentive)
Visual framing softens (e.g., “A little thank you” vs. “Big win”)
Reward may be deferred or offered only post-conversion

### Anti-Exploitation Safeguards

BonusIQ incorporates manipulation resistance logic:
Reward Pattern Recognition: Detects gesture spamming or rage taps designed to trigger incentives.
Randomized Delay Window: Prevents deterministic gaming
Friction-Injection Logic: Slight delay before showing reward after repeated threshold proximity
RecallIQ Coordination: Suppresses repeat reward for suspicious sessions

If adversarial intent is detected, BonusIQ enters fallback mode, logging the event to RecallIQ for future weight tuning.

### BonusIQ—Anti-Gamification and Exploitation Prevention Layer

### Overview

To preserve economic integrity, emotional authenticity, and system trust, BonusIQ includes a dedicated anti-gamification subsystem that detects, classifies, and mitigates reward manipulation attempts in real time. This includes but is not limited to:
Gesture looping (e.g., rage taps, scroll-cancel-scroll)
Repetition of CTA hover without commitment
Deliberate hesitation to trigger passive rewards
Reward-priming behaviors (e.g., app restarts, fake hesitations)
¢ Device mimicry (e.g., auto-clickers or bot patterns)

The system uses a 3-tier defense model comprising:
1. Pattern recognition
2. Threshold gating
3. Session fingerprint entropy

### 1. Pattern Recognition Engine

Behavioral inputs are classified using high-frequency gesture mapping and micro-intent modeling.

### Input Signals:

Number of identical gesture sequences per minute
Time between scroll+back+CTA loop
Variation delta of tap pressure (mobile)
Scroll-back spike density
Time-to-gesture after reward delivery

### AmbientIQ—Emotionally-Aware Personalization in Passive and Non-Interactive Environments

### Overview

AmbientIQ enables emotionally adaptive, privacy-compliant content modulation in non-interactive or passive interfaces, including:
Digital signage (retail, airport, gym, street)
AR overlays or smart glasses
Hotel hallway displays
Waiting room or transit panels
In-store silent sales surfaces
Any screen without direct user input

It operates without user login, cookies, or profile data, using a combination of environmental field signals, anonymous gaze/dwell estimators, and trait projection models derived from localized behavior patterns.

### AmbientIQ Adjusts:

Visual tone
Call-to-action prominence
Animation style
Reward display eligibility
Message frequency and density

### Inputs to AmbientIQ

Environmental signals:
   Time of day
   Location type (e.g., airport, retail)
   Noise level
   Inventory pressure
   Scheduled events (e.g., promotions, flights, concerts)
Passive user signals (when available):
   Dwell time (via gaze, vision, or motion detection)
   Foot traffic volume
   Time spent in proximity
   Repeat presence estimation (non-ID).
Cross-surface handoff signals:
   Trait tokens from previous screen or search session
   QR scan from SiteIQ, AdIQ, or Vectra-integrated session

### Trait Projection Model

In the absence of direct input, AmbientIQ generates a projected Vectra based on environmental compression and behavior norms for the environment type.

### Example:

In a quiet hotel lobby at 10:30 PM:
Projected Vectra:
   Temperature=0.2
   Viscosity=0.7
   Confidence=0.4
   Goal=Delay→Reassure

All trait projections are scoped to time×location archetypes.

### Adaptive Content Controls

AmbientIQ modulates:
Animation intensity: pulse rate, glow speed, CTA entry
Message frequency: per-minute rotation vs. per-session impression
CTA prominence: full-screen vs. sidebar; animated vs. flat
Offer gating: restricts discounts during low-confidence estimates
Reward framing: “Thank you” tone vs. “Big Win” framing

When dwell is detected:
Trait vector is updated in-session
Mutation logic enabled (Convert↔Reassure↔Educate)
QR or CTA surfacing allowed if traits indicate readiness

### Cross-Surface Integration

Session token can be passed via QR, NFC, or visual scan to a mobile device.
Mobile inherits tone, reward state, and goal path
BonusIQ can complete rewards from AmbientIQ if traits stabilize

### Compliance & Ephemerality

All field signals:
Are session-local
Do not persist beyond visual window
Are not linked to camera identity, device ID, or facial biometrics

All emotional adaptation logic is:
Rendered in-session
Tokenized into anonymous explanation trails (optional)
Logged in the Compliance Token Layer (CTL) when active

### SUMMARY

AmbientIQ brings emotional computing to places where interaction is impossible—but experience still matters. It enables signage, displays, and AR panels to:
Soften tone in noisy places
Hold back pressure when stress is high.
Surface opportunity at the right emotional moment
And do all of this without knowing who you are

It makes screens feel less like ads—and more like understanding.

### VoiceIQ—Emotionally Adaptive Interaction Layer for Voice-Based Assistants

### Overview:

VoiceIQ extends the VectraIQ personalization framework into voice-based search and assistant environments, including Google Assistant, Siri, Alexa, and in-car or wearable AI systems. It enables real-time emotional inference from speech cadence, voice intent, interaction rhythm, and request structure—without requiring speaker identification or stored history.

VoiceIQ dynamically adapts:
Spoken tone
Response pacing
Language complexity
Follow-up sequencing
Response suppression or expansion
   . . . based on emotional trait signals generated from voice input and behavioral patterns.

This ensures that every assistant interaction is emotionally responsive, privacy-compliant, and context-aware—regardless of whether the user is logged in or known.

### Inputs to VoiceIQ

Speech recognition transcription
Voice interaction rhythm (pauses, timing between turns)
Repetition or clarification loops
Query framing structure (“Can I . . . ”, “Should I . . . ”, “I think . . . ”)
Noise level, time of day, and device type
Vectra traits (temperature, friction, confidence, elasticity)
   Trait Extraction from Voice Input

VoiceIQ uses a real-time trait extraction layer that processes:
Temperature: Urgency or emotional charge (based on pace and linguistic emphasis)
Friction: Number of clarifications, repeated commands, or hesitations
Confidence: Sentence completeness, directness, and decisiveness
Texture: Variability or instability in rhythm, corrections, or emotional tone

All traits are passed to the central Vectra for integration with tone and goal logic.

### Example Trait Mapping:

| Voice Behavior | Trait Effect |
|---|---|
| Long pause before “what's the weather” | Friction ↑, Confidence ↓ |
| “Should I . . . ”/“Can you maybe . . . ” | Confidence ↓, Temperature ↓ |
| Repeating the same command 3x | Friction ↑↑, Texture ↑ |
| High-volume + fast speech | Temperature ↑, Confidence ↑ |

### Mutation Triggers in Voice Contexts

If VoiceIQ detects rising friction and falling confidence, it triggers:
Goal mutation (e.g., “Convert”→“Reassure”)
Tone override via MomentIQ (e.g., assertive→minimalist)
BonusIQ suppression (gamified suggestions delayed)
Fallback response mode: simpler language, delayed CTA

### Adaptive Tone, Pacing, and Content Behavior

Based on trait thresholds, VoiceIQ modifies:

| Trait State | Voice Output Behavior |
|---|---|
| High viscosity + low temperature | Delays response, reduces |
| | sentence length |
| High friction + mutation to Reassure | Softens voice tone, |
| | increases pause gaps |
| High temperature + high confidence | Uses assertive tone, |
| | fuller prompts |
| Texture spikes post-mutation | Applies soft-ramp: |
| | gentle tone with short cues |

### Cross-Surface Vectra Handoff

When a voice session transitions to screen (e.g., mobile handoff or car-to-home):
The session's Vectra state is transmitted as a token
Trait values and current goal classification travel with it
Tone and CTA behavior persist across modalities without reinitialization

### Example:

User tells Assistant “I'm thinking about refinancing”→Vectra triggers “Educate” goal→When user taps link in mobile display, offer tone remains soft and MomentIQ delays CTA presentation.

### Federated Learning via RecallIQ

VoiceIQ sessions are included in RecallIQ's federated learning loop:
*Trait→outcome associations (e.g., “Reassure”→re-engagement)
Speech interaction archetypes (e.g., “late-night exploratory”, “morning task mode”)
Anonymized performance data (e.g., clarification loops, early abandon)

All updates are differentially private and zero-ID.

### Compliance and Transparency

All emotional adaptation logic:
Operates entirely in-session
Discards signals post-session
Logs trait-to-output rationale in the Compliance Token Layer (CTL)
Never stores or links to voiceprint, speaker ID, or PII

### SUMMARY

VoiceIQ enables large-scale emotional computing in ambient, screenless, or speech-first environments. It empowers AI agents to:
Speak more gently under stress
Offer softly framed choices
Know when to hold back
And never require a login or cookie to be helpful

It makes Google Assistant, Siri, and other voice agents emotionally smart and privacy-native—across every device, user, and environment.

### Gamification Risk Score (GRS):

$$GRS = {μ}_{1} \cdot GestureLoopRate + {μ}_{2} \cdot ScrollbackRate + {μ}_{3} \cdot DelayInversionIndex$$

### Where:

μₙ=trait-aligned weights
DelayInversionIndex=ratio of idle time before and after reward events

### Thresholds:

GRS>0.8: Flag session as at-risk
GRS>1.2: Suppress reward; notify RecallIQ

FIG. 29: Gamification Risk Score (GRS) Formula—This BonusIQ model identifies potential reward manipulation by computing a Gamification Risk Score (GRS) from GestureLoopRate, ScrollbackRate, and the DelayInversionIndex (idle time before vs. after a reward event). If GRS>0.8GRS>0.8GRS>0.8, the session is flagged as potentially adversarial; if GRS>1.2GRS>1.2GRS>1.2, reward exposure is suppressed and RecallIQ is notified for reinforcement tuning. This mechanism ensures ethical, emotionally safe gamification without overexposure or exploitation.

### 2. Threshold Gating & Randomization

BonusIQ applies entropy buffers and randomized delay logic to prevent predictable reward exposure.
Entropy-Gated Reward Delay:

$${RewardDelay}_{final} = BaseDelay + Random ( 250 , 750 ) + EntropyScore \cdot ϵ$$

### Where:

EntropyScore is derived from confidence decay, emotional volatility, and prior hesitation frequency.
Cooldown Enforcement: After a reward event, a hidden cooldown timer is applied:
   Mild friction→5-10s
   Suspected gamification→30s+
   Confirmed manipulation→reward disabled for session

FIG. 30: Entropy-Gated Reward Delay and Cooldown Enforcement—This BonusIQ formula delays reward exposure using a combination of randomized buffering and entropy-based scaling. The Entropy Score reflects confidence decay, emotional volatility, and prior hesitation frequency, making reward timing less predictable and more emotionally attuned. A hidden cooldown timer is also enforced post-reward, ranging from 5 seconds for mild friction to full suppression in cases of confirmed manipulation—ensuring ethical, non-exploitable gamification behavior.

### 3. Session Fingerprint Entropy

To detect multi-surface or multi-device manipulation, the system computes a Session Entropy Profile using signal diversity, rhythm variance, and device timing jitter.

### Entropy Check:

$$Entropy = \frac{{σ}_{interlap}}{{μ}_{interlap}} + TrailVolatilityVariance$$

Low entropy=repeated, unnatural precision→suppress rewards
High entropy=natural behavior→allow variability-driven exposure

FIG. 31: Session Fingerprint Entropy Formula—This equation calculates a session's entropy profile to detect unnatural patterns such as bot activity or reward gaming. Entropy is derived from intertap timing variance and trait volatility spread. Low entropy indicates mechanical or manipulated input and results in suppressed rewards, while high entropy suggests human-like variability—enabling BonusIQ to expose variability-driven incentives with confidence and compliance.

### Adaptive Countermeasures

If manipulation is suspected:
BonusIQ enters quarantine mode
Reward is delayed, replaced, or suppressed
Session token is flagged anonymously for RecallIQ
Symbolic message replaces reward (e.g., “Thanks for exploring!”)

### Cross-Engine Coordination

MomentIQ adjusts tone to discourage probing
RecallIQ logs and trains resistance model
AffordIQ reduces offer escalation during high-risk sessions
BonusIQ rotates or disables high-value reward formats (e.g., disables spin wheel, enables badge)

### Compliance and Explainability

All reward suppression decisions are:
Logged in the Compliance Token Layer (CTL)
Optionally tagged with rationale: e.g., “Repeated hesitation pattern detected-reward paused”
Never stored with identity
Discarded at session end

### SUMMARY

The anti-gamification layer ensures BonusIQ remains:
Emotionally honest.
Economically defensible
Resistant to manipulation
Compliant with fairness principles and personalization ethics

By dynamically modeling behavioral entropy and friction rhythm, it protects both the platform and the user from emotionally shallow or exploitative interactions.

### Reversal-Aware Reactivation

If a session goal reverses (e.g., Reassure→Convert), BonusIQ reactivates the reward path using a soft-ramp model:
Step 1: Delay re-exposure window
Step 2: Reduce animation intensity
Step 3: Gradually increase tone strength
Step 4: Enable high-value reward only if confidence recovers

This ensures emotional coherence and prevents reward misalignment during volatile transitions.

### Cross-Surface Synchronization

In multi-surface deployments (e.g., AmbientIQ signage→SiteIQ mobile), BonusIQ:
Transfers reward status using session token
Remembers prior suppression or partial exposure
Completes delayed or QR-based rewards if context allows

### Example:

User pauses at signage→Mutation to “Delay”→Reward QR appears

User scans and resumes on mobile→BonusIQ completes spin wheel after confidence rebound

Outputs from BonusIQ
Reward eligibility flag (true/false)
Recommended reward type (symbolic, timed, surprise)
Framing strategy (gentle, assertive, playful)
Delay time (ms)
Suppression reason (if blocked)
Reward resonance metadata (logged to RecallIQ)
Economic justification flag (from AffordIQ)

### Fallback and Offline Behavior

BonusIQ supports offline deployment with:
Precompiled reward logic tables
Edge-triggered suppression for fragile goals
Offline resonance logging
Local-only symbolic reward fallback (e.g., badge, message)

Post-session, all reward performance is shared with RecallIQ via differentially private delta uploads.

### Compliance and Transparency

All reward decisions, exposures, and suppressions are:
Logged in the Compliance Token Layer (CTL)
Explained via optional explanation tokens (e.g., “Reward held due to high friction”)
Not linked to identity, and reset at session end

### SUMMARY

BonusIQ is a real-time gamified personalization module that adapts reward behavior to session emotion, goal state, and economic viability. It is:
Emotionally intelligent
Resilient to gaming
Business-aligned
Fully privacy-safe

It ensures that rewards are earned—not exploited—and that they feel appropriate, motivating, and meaningful, even as user needs shift moment-to-moment.

### Session Initialization and Trait Engine

Upon session initiation, a Vectra is instantiated with baseline emotional traits:
Temperature
Viscosity
Texture
Density
Confidence
Friction Index

These traits are continuously updated through the Trait Engine, which receives interaction signals such as scroll velocity, dwell time, gesture loops, CTA avoidance, and contextual overlays (e.g., noise level, time of day). All trait values are computed using weighted formulas and decay over time unless reinforced.

### Trait Update Example:

$$Copy \qquad Edit$$

$$Trait\_i ( t ) = {Trait\_i}_{0} \times e \hat{} ( - {λ}_{1} \times t )$$

FIG. 32: Trait Decay Function (Session-Scoped)—This formula models how a behavioral trait Traiti(t)\text{Trait}_i(t)Traiti(t) weakens over time without reinforcement. Governed by an exponential decay curve, it ensures that stale behaviors (e.g., a momentary spike in friction or urgency) lose influence unless sustained, allowing the system to remain responsive to current emotional conditions while maintaining privacy by avoiding history retention.

This decayed trait vector determines the current behavioral-emotional state of the session.

### Goal Mutation Logic

The IntentIQ engine evaluates the decayed confidence score and mutation readiness signal. If the confidence score drops below a dynamic threshold, and volatility or friction increase, the engine mutates the session goal (e.g., “Convert”→“Reassure”).

### Mutation Model Example:

$$cpp \qquad Copy \qquad Edit$$

$$Confidence Score ( CS ) = \sum ( Wi \times Si \times e \hat{} ( - λ i \times Ti ) )$$

FIG. 33: Confidence Score (CS) Calculation—This formula computes the real-time Confidence Score as a weighted, time-decayed sum of behavioral signals. Each input SiS_iSi is weighted by its importance WiW_iWi and diminishes over time via its specific decay constant λi\lambda_iλi. This score reflects directional clarity and is used to determine goal stability, trigger mutations, and guide tone calibration across the session—without retaining user identity or prior sessions.

Where Wi is the weight, Si the strength, and Ti the time since the last reinforcement of signal i.

Each goal is classified within a continuous engagement field:
Convert
Delay
Educate
Reassure
Abandon
Explore

Reversal logic allows previously mutated goals to return to prior classifications if confidence rebounds or engagement stabilizes.

### Tone and Reward Orchestration

The MomentIQ engine adjusts the tone of content based on:
Vectra trait values (e.g., high viscosity=soft tone)
Time-of-day
Ambient noise
Mutation and reversal states

Tone categories include:
Friendly
Assertive
Reassuring
Minimalist
Silent
Educator

The BonusIQ engine adapts reward logic by delaying or suppressing incentives based on trait thresholds and mutated goal states. It supports:
Spin-to-win mechanics
Soft reveals
Symbolic or loyalty rewards
QR-based surprises (e.g., in signage or POS)

Rewards are filtered through AffordIQ for economic justification and through MomentIQ for emotional alignment.

### MedIQ—Clinical and Compliance-Sensitive Personalization Engine

MedIQ is a domain-specific personalization engine optimized for emotionally and legally sensitive environments such as healthcare, diagnostics, and patient-facing interfaces. It interprets behavioral, contextual, and environmental signals with elevated caution and applies specialized logic to modulate tone, delay call-to-action elements, suppress incentive exposure, and restrict engagement escalation when emotional or regulatory thresholds are crossed.

Unlike generalized personalization engines, MedIQ is tailored for clinical and health-regulated contexts and includes support for HIPAA-, FERPA-, and GDPR-compliant deployment. It delays or suppresses conversions during hesitation, risk evaluation, or consent review, and ensures all outputs remain emotionally appropriate and legally compliant. MedIQ may also operate in hybrid privacy models in partnership with covered entities.

MedIQ is the first instantiation of a broader regulatory-aware framework, adaptable to adjacent verticals including finance, law, insurance, and public sector deployments. In these environments, emotional restraint, tone safety, and compliance-aligned pacing are critical to ethical and effective personalization.

MedIQ communicates directly with IntentIQ, MomentIQ, and AffordIQ to:
Override aggressive goal mutation in vulnerable moments
Enforce soft-ramp tone strategies in high-risk disclosures
Suppress reward or upsell mechanics in medical decision contexts
Annotate decisions with compliance-safe explanation tokens via the CTL (Compliance Token Layer)

All MedIQ logic operates within the session boundary and does not require, store, or reference user identity, health data, or persistent behavioral profiles.

### SensIQ: Real-Time Emotional State and Intent Detection

SensIQ is a vertical-specific deployment arm of the XyloIQ personalization platform, optimized for emotionally charged or consent-sensitive interaction environments, including adult content platforms, intimacy-related services, and sexual wellness interfaces. SensIQ enforces strict emotional alignment policies in-session, adapting tone, content pacing, and CTA logic based on indicators of hesitation, volatility, and consent posture. It is designed to minimize coercive or manipulative interface dynamics, delay escalation during fragile emotional states, and reinforce user agency across high-friction or emotionally ambiguous moments. All SensIQ logic is governed by session-local behavioral inputs and operates in full compliance with privacy regulations, requiring no identity, login, or persistent profile history.

### SearchIQ—Emotional Interpretation and Goal Mutation Layer for Search

### Overview:

SearchIQ is a privacy-first submodule of the XyloIQ architecture that decodes the emotional, cognitive, and motivational posture embedded in real-time search queries. It operates during and immediately after query input—without requiring user identity, history, or tracking—and uses a blend of linguistic analysis, behavioral rhythm, and Vectra trait computation to influence downstream decision logic across Search, Shopping, AdIQ, LLMs, and content surfaces.

SearchIQ transforms each query event into a non-identifying emotional signal, contributing to Vectra deformation and goal classification. This enables emotionally intelligent mutation from “Convert” to “Educate” or “Reassure” without storing intent labels, profiles, or search history. While goal attractors are defined as discrete nodes for interpretability and orchestration purposes, the system supports a continuous range of engagement goals through real-time trait vector modulation. This allows for infinite nuance—e.g., ‘Convert with uncertainty,’ ‘Delay with optimism,’ or ‘Reassure under time pressure’—each inferred from unique combinations of emotional trait vectors and environmental overlays.

### Inputs to SearchIQ

Raw query string
Query cadence and typing hesitation
Use of question words (“how,” “should I,” “safe”)
Misspellings or deletions (emotional turbulence)
Repeat queries or rapid query loops
Query modifiers (e.g., “cheap,” “emergency,” “now”)
Session Vectra traits (from VectraIQ)
Device, time, and environmental field conditions

### Query Trait Translation Engine

Each search query is parsed and translated into a weighted trait delta, impacting the current session Vectra:

Examples:
“Best divorce lawyer near me”→friction ↑, curiosity ↑, confidence ↓
“Are treadmills safe after ACL surgery”→urgency ↑, confidence ↓, goal=Educate
“Buy elliptical”→“free elliptical”→“how to get elliptical insurance”→mutation from Convert→Delay→Reassure

Trait shifts are scored and passed to IntentIQ for real-time goal reclassification.

### Search Tone Modifier

SearchIQ can generate a tone modifier token passed to:
AdIQ for copy calibration (e.g., “Tone=Reassure, CTA=Optional”)
Gemini/LLMs to adjust instructional output
Google Shopping to reduce urgency visuals or suppress timers

### Emotional Mutation Criteria

SearchIQ uses a combination of:
Query-level tone scoring
Trait change detection
Friction prediction
Typing rhythm volatility

If a mutation threshold is crossed, the current engagement goal mutates mid-query or between search and click.

### Cross-Platform Application

SearchIQ Vectra states can be shared downstream to:
Gemini (Gemini receives emotional trait vector instead of profile)
AdIQ (emotional copy shifting per trait state)
Chrome Suggestions (delay or soften autocomplete when Vectra=“Reassure”)
Google Shopping (frame offers in tone-aligned visuals)

All tokens expire and are session-local only.

### SUMMARY

SearchIQ makes Google Search emotionally aware—without knowing who you are. It uses real-time emotional inference to adapt tone, suggest more relevant follow-ups, and redirect misaligned goal states—all in full compliance with zero-ID requirements.

### Environmental Field Modulation

The system uses a Field Warp Layer to apply gravitational distortion to the engagement field. Inputs include:
Time of day
Noise classification
Inventory urgency
Device type
Location context

These affect trait weighting and mutation thresholds. For example, rainy weather plus noise volatility increases viscosity and may lower the mutation threshold to “Delay.”

### Federated Learning and Edge Mode

The RecallIQ engine continuously learns from in-session decisions using a multi-armed bandit framework. Outcome scores from goal mutations, reward responses, and tone effectiveness inform threshold adjustments.

In edge deployments (e.g., smart signage, vending, tablets), the system operates locally with:
Cached confidence scoring models
Precompiled mutation graphs
Deferred reward logic
Offline re-synchronization upon connectivity restoration

### API & Cross-Surface Tokenization

The system exposes an identity-free API layer, allowing developers to:
Inject behavioral signals
Retrieve trait vectors, tone states, or goal classifications
Trigger reward logic (or suppress)
Override tone or goal for compliance

A Session State Token allows VectraIQ to pass state metadata across surfaces:
goal
tone
reward readiness
mutation path

Example: A smart mirror session mutates from “Convert” to “Delay,” and the user scans a QR.

The mobile experience continues with the same tone and reward delay settings.

### Visualization and Explanation Layer

The Vectra structure may be visualized in real time, with fluid traits mapped to:
Glow (temperature)
Drag/motion delay (viscosity).
Ripple frequency (texture)
Rotation or pulse rate (confidence)

Each content decision may include a session-local explanation token, which references:
Goal classification
Mutation event
Confidence score
Contextual signal (e.g., “You paused on pricing and we adjusted the tone”)

All tokens are destroyed at session close.

### Privacy and Regulatory Compliance

All data flows are zero-ID:
No PII
No device fingerprinting
No stored cookies or cross-session profiles

Mutation logic, tone adjustments, and offer selection are auditable via the Compliance Token Layer (CTL), which captures:
Trait deltas
Mutation causes
Economic and emotional justifications.
Tone override signals

The system is designed to comply with:
GDPR
CCPA
HIPAA
FERPA
EU AI Act

### CONCLUSION

This preferred embodiment enables dynamic, emotionally intelligent, and privacy-compliant personalization using a real-time trait engine, goal mutation logic, cross-surface orchestration, and federated learning. The Vectra model allows personalization to evolve in-session in a non-invasive and fully anonymous manner, making it suitable for deployment across mobile, web, signage, in-room tablets, kiosks, voice agents, and smart environments.

### Developer Integration and Modular API Access

The XyloIQ platform provides a fully modular and composable API layer for developers to integrate the personalization engine stack into existing content management systems (CMS), commerce platforms, analytics frameworks, customer experience tools, and cross-surface UI rendering engines. The platform is designed for plug-and-play use in both frontend and backend environments and supports real-time, privacy-compliant data exchange.

### Integration Objectives

The API framework enables developers to:
Inject real-time behavioral signals into the XyloIQ engine stack
Receive session-local goal, tone, and reward state metadata
Control personalization decisions based on business logic or override rules
Operate in identity-free mode across web, mobile, kiosk, voice, signage, and ambient displays
Sync personalization logic across multiple interaction surfaces in real time

All APIs are identity-free by default and structured for compliance with privacy frameworks including GDPR, CCPA, HIPAA, and FERPA.

### API Endpoints and Capabilities

### 1. Session Initialization

| | | |
|---|---|---|
| http | [symbol] Copy | [symbol] Edit |
| POST /api/session/init | | |

FIG. 34: API Session Initialization Endpoint—This endpoint (POST/api/session/init) represents the entry point for launching a zero-identity session in the VectraIQ system. Upon invocation, a session is instantiated without requiring user login, cookies, or tracking identifiers. It initializes a new Vectra object for real-time emotional modeling and ensures all downstream personalization remains privacy-compliant.

Creates a new zero-ID session and returns a session token.

| Input: | | |
|---|---|---|
| json | [symbol] Copy | [symbol] Edit |
| { | | |
| “device_type”: “mobile”, | | |
| “deployment_mode”: “Site10”, | | |
| “geo_zone”: “checkout_zone”, | | |
| “referrer”: “ad_campaign_64” | | |
| } | | |

FIG. 35: Session Context Metadata (JSON Example)—This JSON payload demonstrates session-local context passed during VectraIQ initialization. Metadata such as device type, deployment mode (e.g., SiteIQ), geographic zone, and referral source help shape trait computation and engagement logic without using personal identifiers. These values inform emotional field warping, trait weighting, and tone modulation-all while maintaining full zero-ID compliance.

Output:

| | | |
|---|---|---|
| json | [symbol] Copy | [symbol] Edit |
| { | | |
| “session_token”: “anon-789xyz”, | | |
| “initial_goal”: “Browse”, | | |
| “confidence_score”: 0.88 | | |
| } | | |

FIG. 36: Session State Token (Privacy-Safe Output Example)—This JSON snippet illustrates a session-local output from VectraIQ, containing a non-identifying session token, the inferred initial goal, and the real-time confidence score. This token enables downstream engines (e.g., MomentIQ, BonusIQ) or third-party systems to align tone, pacing, and reward logic—without tracking users, storing identity, or linking session history across surfaces.

### 2. Send Behavioral Signal

| | | |
|---|---|---|
| http | [symbol] Copy | [symbol] Edit |
| POST /api/session/signal | | |

FIG. 37: Real-Time Signal Injection Endpoint—This API call (POST/api/session/signal) enables client systems to stream behavioral or environmental signals (e.g., scroll velocity, tap cadence, dwell time) into the VectraIQ engine in real time. These signals are used to update trait values dynamically, ensuring each personalization decision reflects current emotional posture—without requiring cookies, profiles, or identity-based tracking.

Used to stream real-time input signals such as scroll depth, tap cadence, hover behavior, and gesture data.

Input:

| | | |
|---|---|---|
| json | [symbol] Copy | [symbol] Edit |
| { | | |
| “session_token”: “anon-789xyz”, | | |
| “signals”: { | | |
| “scroll_depth”: 0.71, | | |
| “tap_velocity”: 0.33, | | |
| “gesture_pattern”: “tap-hold-padse”, | | |
| “idle_druation”: 7.4, | | |
| “friction_signals”: 3 | | |
| } | | |
| } | | |

FIG. 38: Real-Time Signal Payload (JSON Example)—This JSON payload shows a sample real-time signal update passed to the VectraIQ engine during an active session. It includes gesture-based behavioral inputs such as scroll depth, tap velocity, idle duration, and a composite gesture pattern (e.g., “tap-bold-pause”). These inputs update emotional trait vectors on the fly, guiding tone, pacing, and personalization decisions without requiring user identity or persistent storage.

Output:

| json | [symbol] Copy | [symbol] Edit |
|---|---|---|
| { | | |
| “traits”: { | | |
| “Temperature”: 0.38, | | |
| “viscosity”: 0.81, | | |
| “texture”: 0.65, | | |
| “confidence”: 0.43, | | |
| }, | | |
| “goal”: “Delay”, | | |
| “tone”: “Minimalist”, | | |
| “reward_ready”: false | | |
| } | | |

FIG. 39: Session Trait State Output (JSON Response)—This example response from the VectraIQ engine shows the computed emotional trait values (temperature, viscosity, texture, confidence), the current goal classification (“Delay”), the selected tone (“Minimalist”), and the reward readiness flag (false). This session-local output allows downstream modules to adjust tone, pacing, and gamification eligibility in real time—without persisting identity, history, or behavioral linkage.

### 3. Retrieve Personalization Recommendations

| | | |
|---|---|---|
| http | [symbol] Copy | [symbol] Edit |
| GET /api/session/state | | |

FIG. 40: Session State Retrieval Endpoint—This API call (GET/api/session/state) allows authorized systems to query the current emotional state of a session in progress. It returns traits (e.g., temperature, confidence), the active goal, tone classification, and reward readiness—enabling synchronized personalization across surfaces while maintaining strict zero-ID architecture.

Returns the latest computed personalization state.

Output:

| json | [symbol] Copy | [symbol] Edit |
|---|---|---|
| { | | |
| “goal”: “Reassure” | | |
| “mutated_form”: “Convert”, | | |
| “confidence_score”: 0.37, | | |
| “tone_recommendation”: “Soft”, | | |
| “offer_eligibility”: “Deferred”, | | |
| “reward_frame”: “Suppressed”, | | |
| “muatution_rationale”: “High friction + idle stall” | | |
| } | | |

FIG. 41: Session Output with Explanation Token (JSON Format)—This response illustrates a full decision snapshot from the VectraIQ engine. It shows a goal mutation from “Convert” to “Reassure”, along with supporting metadata: confidence score, tone recommendation, offer eligibility, reward suppression, and a clear human-readable mutation rationale (“High friction+idle stall”). This explanation token is logged session-locally for audit, debugging, or UX transparency—without storing any identity or persistent behavioral history.

### 4. Trigger BonusIQ or Reward Event

| | | |
|---|---|---|
| http | [symbol] Copy | [symbol] Edit |
| POST /api/session/trigger/reward | | |

FIG. 42: Reward Trigger Endpoint (BonusIQ API Call)—This endpoint (POST/api/session/trigger/reward) initiates a reward eligibility check within BonusIQ. Based on current emotional traits, RRS score, and economic constraints (e.g., EIS), the system determines whether to expose, delay, or suppress a reward. All decisions are computed in-session, logged to the Compliance Token Layer, and executed without user identity or behavioral profiling.

Optionally used by client applications to request BonusIQ eligibility check or manually trigger gamified elements if allowed.

Input:

| json | [symbol] Copy | [symbol] Edit |
|---|---|---|
| { | | |
| “session_token”: “anon-789xyz”, | | |
| “context”: { | | |
| “inventory_level”: “moderate”, | | |
| “engagement_score”: 0.58 | | |
| } | | |
| } | | |

FIG. 43: Session Context Snapshot with Inventory and Engagement Signals—This session-local JSON payload includes contextual modifiers such as inventory level and real-time engagement score. These variables can influence offer pacing, tone modulation, and reward eligibility via AffordIQ and BonusIQ logic. Importantly, the data remains session-bound, with no persistent identifiers, aligning with VectraIQ's zero-ID design philosophy.

Output:

| json | [symbol] Copy | [symbol] Edit |
|---|---|---|
| { | | |
| “reward_status”: “Suppressed” | | |
| “reason”: “Emotional state = Reassure”, | | |
| “suggested_delay”: “15 seconds” | | |
| } | | |

FIG. 44: Reward Suppression Output with Rationale and Delay—This BonusIQ response communicates a reward suppression decision, citing the active emotional state (“Reassure”) and recommending a 15-second delay before re-evaluation. This type of session-local explanation enables transparency and traceability of adaptive behavior while maintaining full compliance with VectraIQ's zero-identity architecture.

### 5. Override or Influence Goal Classification (Optional Enterprise Use)

This clearly communicates that the functionality described allows enterprises to optionally and manually override or influence automated goal classification within the system.

| | | |
|---|---|---|
| http | [symbol] Copy | [symbol] Edit |
| POST /api/session/override | | |

FIG. 45: Session Override Endpoint for Enterprise Control—This API call (POST/api/session/override) allows authorized systems to inject override instructions into an active VectraIQ session. Overrides may adjust goal state, tone policy, reward eligibility, or pacing behavior—commonly used in regulated, brand-sensitive, or compliance-mandated environments. All overrides are logged with rationale and never override user identity, maintaining full zero-ID fidelity.

Enterprise partners may use this endpoint to influence system behavior in strategic, campaign, or regulatory contexts.

Input:

| json | [symbol] Copy | [symbol] Edit |
|---|---|---|
| { | | |
| “session_token”: “anon-789xyz”, | | |
| “override_goal”: “Educate”, | | |
| “reason”: “Compliance mode - prevent upsell” | | |
| } | | |

FIG. 46: Goal Override Payload with Compliance Rationale—This JSON example shows a session override command instructing the system to shift the current goal to “Educate” due to an active compliance mode (e.g., to prevent upsell). The override maintains the session token for continuity but enforces policy without identity or profiling, aligning with enterprise-grade, zero-ID governance standards.

Output:

| json | [symbol] Copy | [symbol] Edit |
|---|---|---|
| { | | |
| “confirmed_goal”: “Educate” | | |
| “override_applied”: true, | | |
| “suppressed_engines”: [“BonusIQ”] | | |
| } | | |

FIG. 47: Override Confirmation and Engine Suppression Response—This JSON response confirms that a session override was successfully applied, setting the confirmed goal to “Educate” and suppressing BonusIQ (the reward engine). Such overrides allow compliance, policy, or regulatory priorities to dynamically influence VectraIQ behavior in-session—without storing personal identifiers or linking session history.

### Cross-Surface Synchronization

The platform provides support for multi-surface state continuity using ephemeral, non-identifying session tokens. These tokens carry metadata between surfaces such as:
Current goal classification (e.g., “Reassure”)
Confidence score and decay curve
Tone recommendation and suppression state
Reward eligibility flag
Mutation and reversal history

This allows personalization behavior to persist when the session moves from:
Kiosk to mobile (e.g., scan a QR on signage→launch mobile site with same tone)
Web to CTV (e.g., SiteIQ data informs AdIQ)
In-room tablet to smart mirror or POS

Tokens expire automatically at session end or after defined timeouts and are never stored beyond their use window.

### Developer SDK and Event Hooks

A lightweight JavaScript SDK is provided for client-side deployments (e.g., SiteIQ, retail, or CTV integrations), enabling:
Real-time signal injection.
Event-based mutation listening
Tone override control
Dynamic CTA rendering logic based on current session goal

### Example Event Hook:

| javascript | [symbol] Copy | [symbol] Edit |
|---|---|---|
| XyloIQ.onMutationChange( (mutation) => { | | |
| if (mutation.goal === “Reassure”) { | | |
| disableCountdown( ); | | |
| showComfortToneHeader( ); | | |
| } | | |
| ) ); | | |

FIG. 48: Developer Hook for Goal Mutation Event (JavaScript Example)—This client-side code sample shows how a developer might subscribe to XyloIQ's goal mutation event and modify interface behavior accordingly. In this case, when the session goal mutates to “Reassure,” the system disables urgency-based countdowns and activates comfort tone UI elements. This demonstrates real-time, privacy-safe UX adaptation based on emotional posture—without identity or history.

### Compliance and Observability

All API transactions are automatically logged to the Compliance Token Layer (CTL) in a privacy-safe, ephemeral format. These logs include:
Trait scores
Mutation decisions
Reason codes
Regulatory flags (e.g., “HIPAA mode active”)

Enterprises may access CTL tokens via audit dashboards or log exports in formats compliant with NIST RMF, EU AI Act, or internal oversight frameworks.

### Supported Formats and Standards

JSON over HTTPS
Optional WebSocket for high-frequency signal streaming (e.g., kiosk, signage)
RESTful architecture with token-based authentication
Webhooks for real-time updates to external systems (e.g., CRM, CMS)

This modular API layer allows XyloIQ to operate as both a standalone personalization engine and an embeddable layer across any interaction stack-providing enterprise-grade behavioral modeling, tone calibration, and offer optimization without requiring persistent identity or profile storage.

| | Legacy Personalization | |
|---|---|---|
| Compliance Criterion | Systems | XyloIQ (VectraIQ Platform) |
| GDPR Compliance | [symbol] Relies on identity, | [symbol] Fully zero-ID; no PII, no cookies, |
| | cookies, tracking | no profiling |
| CCPA Compliance | [symbol] Requires opt-outs, | [symbol] Default-compliant; no need for opt- |
| | collects user history | outs |
| HIPAA Readiness (Health | [symbol] Cannot suppress tone of | [symbol] MedIQ engine enforces tone, |
| Use Cases) | CTA in sensitive states | reward, CTA suppression in high-risk |
| | | scenarios |
| FERPA Compatibility | [symbol] Tracks learner sessions, | [symbol] Session-local logic only; no |
| (Education) | may retain IDs | persistent identifiers |
| EU AI Act Alignment | [symbol] Non-explainable LLMs | [symbol] Includes Explanation Token Layer |
| | and personalization logic | (ETL); decisions are human-readable |
| | | and auditable |
| Zero Identity Architecture | [symbol] Identity-based by | [symbol] Zero-ID across stack, including all |
| | default | signals and outputs |
| Real-Time Consentless | [symbol] Requires consent to | [symbol] Operates without consent, fully |
| Operation | personalize legally | compliant |
| Explainability & Audit | [symbol] Opaque decision logic | [symbol] Each mutation, tone shift, and |
| Readiness | | reward is logged as a non-identifying |
| | | rationale token |
| Federated Learning | [symbol] Rarely implemented or | [symbol] Federated RecallIQ trains models |
| Support (Privacy- | compliant | without identity or history |
| Preserving) | | |
| Cross-Surface Continuity | [symbol] Requires login or user | [symbol] Session tokens allow tone and goal |
| Without ID | session persistence | continuity across signage, mobile, |
| | | POS, etc. |

### Gemini Integration: Real-Time Emotional Modulation of LLM Output

The VectraIQ engine can be deployed as a middleware layer between user-facing applications and large language models such as Google Gemini. During each session, VectraIQ computes an emotional trait vector (e.g., confidence, viscosity, volatility) based on live behavioral signals-such as typing cadence, scroll rhythm, correction loops, and interface pacing.

These traits are transformed into a Tone Modulation Token, which is passed via API to Gemini alongside the user prompt. This token adjusts Gemini's response tone, complexity, pacing, and follow-up cadence in real time, without using user identity or persistent session history.

Example Scenario:
Trait vector: Confidence ↓, Friction ↑, Viscosity ↑
Goal mutation: Convert→Reassure
Tone Modulation Token: {tone: “reassuring”, pace: “slow”, complexity: “simple”, followup: false}
Gemini response output:
   “No problem. Take your time. If you′d like, I can walk you through the options step by step.”

This integration allows Gemini to deliver emotionally aligned responses on the fly, ensuring that users receive helpful, context-aware support—even in emotionally volatile or uncertain states—without requiring profiles, cookies, or stored history.

The VectraIQ token can also be shared with Gemini in cross-surface handoffs (e.g., from SiteIQ to Gemini Chat), preserving tone and engagement posture without identity continuity.

AdIQ Integration with Google Ads Creative Studio

The AdIQ module, part of the XyloIQ platform, enables real-time, privacy-safe emotional trait tokenization during active user sessions. These tokens are generated by analyzing immediate behavioral signals, including scroll patterns, CTA (call-to-action) avoidance, hesitation loops, tap reversals, and micro-hesitation indicators. Each token precisely captures the user's current emotional state without the use of personal identities, cookies, or stored historical data.

At moments of high engagement—such as when an ad becomes viewable, an ad slot request occurs, or an outbound click is initiated—the AdIQ system creates a trait token designed for API integration with external advertising platforms like Google Ads Creative Studio. Each trait token includes critical fields such as:
Current Engagement Goal: e.g., “Convert,” “Delay,” or “Reassure”
Tone Recommendation: e.g., “Assertive,” “Minimalist,” or “Reassuring”
Confidence Score: a scalar value (e.g., 0.42)
Friction Index: a scalar value indicating resistance or hesitation (e.g., 0.73)
Urgency Override Directive: e.g., “suppress,” “soften,” or “maintain”

These trait tokens, once delivered to the ad rendering platform, dynamically adjust ad content in real-time. The ad platform can select from various creative assets or dynamically adjust copy and animations based on the guidance provided by these tokens.

### Example Workflow:

A user demonstrates hesitation during checkout, marked by significant friction and declining confidence.
AdIQ identifies the current goal as “Reassure” and generates the following trait token:

```
{
    “goal”: “Reassure”,
    “tone”: “soft”,
    “confidence”: 0.4,
    “friction”: 0.7,
    “urgency_mod”: “suppress”
}
```

FIG. 49. Example of an AdIQ-generated emotional trait token capturing real-time user hesitation, ready for integration with Google Ads Creative Studio.
Google Ads Creative Studio ingests this token and modifies the ad accordingly:
   Original Ad: “Buy Now—Limited Time Offer”
   Adapted Ad: “Still thinking it over? Save your spot—no pressure.”

This integration supports adaptive, emotionally responsive ad personalization throughout Google's ad network while fully complying with global privacy regulations, including GDPR, HIPAA, FERPA, and the EU AI Act. It operates without user login requirements, persistent identifiers, or historical targeting profiles, relying exclusively on real-time behavioral data from the current session.

AdIQ thus functions as an emotional-signal bridge, linking XyloIQ's privacy-first emotional analysis engine directly to real-time ad personalization systems. This empowers advertisers to improve click-through rates, reduce bounce rates, and enhance brand trust by aligning their messaging with users' emotional states at the precise moment of interaction.

### Example Workflow:

A user demonstrates hesitation during checkout, marked by significant friction and declining confidence.
AdIQ identifies the current goal as “Reassure” and generates the following trait token:

### SiteIQ SDK for Chrome and Android: Zero-ID UX Adaptation

The SiteIQ deployment arm of XyloIQ may be instantiated as a lightweight browser extension (e.g., Chrome) or an embeddable Android SDK. These implementations enable any website or mobile app to deliver emotionally aligned, zero-identity personalization using in-session behavioral modeling—without modifying backend infrastructure or relying on cookies, profiles, or CRM data.

Once installed, the SiteIQ SDK performs real-time Vectra generation and trait computation locally, using observable interaction signals including:
Scroll velocity and acceleration
Tap or click hesitation
Form revisit loops
Hover-back patterns
Session idle time and reactivation
Field abandonment or correction cadence

These signals feed a local instance of the VectraIQ trait engine, which computes emotional posture traits such as confidence, friction, viscosity, and urgency. No signals are stored or transmitted unless explicitly permitted by the host application.

### Example Chrome Extension Use Case:

A user is browsing a product page and repeatedly toggles between pricing and return policy links.
The SiteIQ extension detects elevated texture (reversal), confidence decay, and friction.
The Vectra's goal mutates from “Convert” to “Reassure.”
The extension injects real-time DOM modifications to:
   Soften CTA language (e.g., “Ready when you are”)
   Delay countdown timers or popups
   Add comparison visuals or trust messaging
   Suppress animation intensity of urgency tone

### Example Android SDK Use Case:

A user scrolls slowly through a medical consultation form, hesitates on risk disclosures, and pauses near the “Book Now” button.
The SDK classifies the session goal as “Delay.”
It modifies button copy and pacing locally:
   From: “Schedule Today—Appointments Filling Fast”
   To: “No rush—schedule when you're ready”
BonusIQ reward framing is withheld pending confidence recovery.

All Vectra state logic is confined to the current session. Tokens such as goal state, tone recommendation, and suppression flags may be optionally passed via ephemeral API to render logic, analytics overlays, or session-based personalization tools. No persistent ID, cookie, or cross-session profile is created or retained.

This SDK enables any digital surface—whether enterprise-scale or SMB storefront—to adopt privacy-first emotional intelligence without infrastructure overhaul, while remaining compliant with GDPR, HIPAA, FERPA, CCPA, and EU AI Act standards.

### Informal Claim Concepts (Non-Limiting Examples):

### 1. Session-Based Emotional Trait Modeling

A system that models each session as a deformable object (“Vectra”) composed of emotional traits including confidence, friction, urgency, volatility, viscosity, and temperature—updated continuously based on live behavioral and environmental signals.

### 2. Real-Time Trait Decay and Reinforcement

Each trait decays over time unless reinforced by new input, simulating emotional momentum and loss of intent certainty in real-time personalization.

### 3. Goal Mutation Based on Trait Decay

When confidence decays and friction or volatility rises, the system automatically reclassifies the session's goal (e.g., Convert→Delay or Reassure), modifying tone and interface behavior.

### 4. Cross-Surface Continuity Without Identity

The system passes a non-identifying session token between devices (e.g., signage→mobile or POS→voice assistant), preserving tone, goal state, and reward readiness without using cookies or user ID.

### 5. Tone Modulation Engine (MomentIQ)

A tone engine adjusts voice, visual, or UI messaging tone in real time based on trait thresholds, session context, and current goal (e.g., assertive tone only allowed when viscosity is low and confidence is high).

### 6. Reward Suppression During Emotional Instability

When the system detects high viscosity, low confidence, or emotional volatility, gamified rewards or incentives are paused, delayed, or visually softened to avoid emotional mismatch.

### 7. Offer Framing Based on Goal State

The economic logic engine (AffordIQ) changes pricing strategies and CTA framing based on inferred affordability and emotional posture. For example, “Try now, cancel anytime” appears if the goal mutates to Reassure.

### 8. Zero-ID Federated Learning Loop

A learning engine (RecallIQ) optimizes future personalization logic by anonymously analyzing which tone, goal mutation, or reward paths led to positive outcomes—without storing identity or session history.

### 9. Projected Trait Modeling for Passive Environments

In environments with no direct input (e.g., signage, smart displays), the system generates a projected trait vector using noise, time, location, and dwell estimation, and modulates content accordingly.

### 10. Search Query Emotional Mutation (SearchIQ)

In real-time search interfaces, the system analyzes typing cadence, query structure, and editing behavior to adjust tone or mutate the goal (e.g., Convert→Educate), even mid-query.

### 11. LLM Tone Modulation Middleware

The system converts the session's emotional state into a modulation token that alters the tone, pacing, or sentence complexity of responses from large language models like GPT, Gemini, or Bedrock.

### 12. Nested Vectra Trait Models

Each session Vectra can contain sub-Vectras for different behavioral domains (intent, tone, pricing, reward), which interact and co-evolve. A high-friction state in one may suppress another's output (e.g., rewards).

### 13. Session-Only Trait Destruction

All traits, tokens, and rationale data are destroyed at session close. Nothing is stored or linkable between sessions, ensuring full zero-ID compliance with GDPR, HIPAA, FERPA, and EU AI Act.

### 14. Multi-Vectra Arbitration (Shared Display Mode)

When multiple users interact with the same interface (e.g., digital signage), each Vectra is modeled independently and the system computes a tone or output based on the dominant emotional vector.

### 15. Tone Ramp After Reversal

If a previously reassured user regains confidence, the system applies a “soft ramp” to restore assertive CTAs and reward pacing gradually, preventing abrupt tone shifts.

### 16. Trait-Based Time Dilation

The system adjusts the pacing of CTAs, messages, and animation based on viscosity and volatility. For example, during high resistance, message exposure slows and time windows are extended.

### 17. Gesture-Based Mutation Input for In-Person Sales

A sales rep may tap a tablet discreetly to log friction, hesitation, or confidence decay in-person, which feeds directly into the same Vectra logic without using customer identity.

### 18. Dynamic Reward Framing by Goal State

Gamified rewards (e.g., spin wheels, badges) are framed based on session goal—e.g., “You earned this!” during Convert, or “Thanks for exploring” during Educate or Delay.

### 19. Real-Time Environmental Field Warping

The interpretation of traits is adjusted based on ambient noise, location, time of day, or inventory urgency. E.g., confidence decay is weighted more heavily during finals week at a vending machine.

### 20. Explanation Token for Audit and UX Transparency

Every system decision—goal change, tone modulation, reward suppression—may generate a non-identifying explanation token readable by audit systems or users (e.g., “Tone softened due to high friction”)

### Appendix A: Modular Licensing Rights Matrix

| | Can Be Licensed | White-Label | Embedded SDK |
|---|---|---|---|
| Engine | Separately? | Compatible? | Available? |
| VectraIQ | [symbol] Yes | [symbol] Yes | [symbol] Yes |
| IntentIQ | [symbol] Yes | [symbol] Yes | [symbol] Yes |
| MomentIQ | [symbol] Yes | [symbol] Yes | [symbol] Yes |
| BonusIQ | [symbol] Yes | [symbol] Yes | [symbol] Yes |
| AffordIQ | [symbol] Yes | [symbol] Yes | [symbol] Yes |
| RecallIQ | [symbol] Yes | [symbol] Limited (edge-only) | [symbol] Yes |

### Licensing Notes:

Each engine may be deployed standalone or integrated as part of the full XyloIQ/VectraIQ stack.
White-label options include logo removal, custom branding, or tone-specific configuration.
SDKs are available in JavaScript (web), Android, IOS, and RESTful API formats.
RecallIQ supports edge-mode SDK deployment and federated learning, but direct white-labeling is constrained due to model aggregation protocols.

### International Filing Readiness:

The system architecture, methods, and applications described herein are applicable across global user contexts, modalities, and regulatory environments, and are structured for enablement and protection under international patent frameworks (PCT, EP, JP, CN, etc.).

Licensing Modularity: This invention may be licensed in whole or in part, and embedded into third-party personalization systems, customer engagement platforms, AI assistants, digital signage networks, and commerce environments. All core modules (BonusIQ, AffordIQ, RecallIQ, VectraIQ, Field Decoder, and Feedback Emitter) may be modularly deployed or integrated into enterprise systems with or without UI presence.

This invention is designed for modular licensing. Each engine—VectraIQ, IntentIQ, MomentIQ, AffordIQ, BonusIQ, RecallIQ—may be deployed individually or in combination. This enables SaaS, OEM, white-label, or field-of-use-restricted licensing across industries. The system supports headless API use, in-browser SDK deployment, edge/offline operation, and AI middleware integration (e.g., LLM tone control) for high compatibility with advertising networks, voice platforms, eCommerce engines, and embedded UI stacks.

Conclusion: This invention provides a domain-agnostic, emotionally intelligent, and privacy-native framework for personalization, engagement, and adaptive user interaction. By modeling behavior through emotional motion rather than identity, the system offers a post-cookie, post-cohort foundation for contextual computing, ambient systems, and emotionally responsive AI.

### Vectraverse System Glossary

### Core Concepts

XyloIQ
A modular, privacy-native personalization platform comprising multiple co-evolving engines that adapt tone, content, offer logic, and reward strategy in real time—without requiring identity, cookies, or persistent profiles.
Vectra
A deformable digital object representing a single session's emotional and behavioral state. Each Vectra evolves in real time based on interaction signals and environmental inputs, exhibiting properties such as temperature, viscosity, texture, and density.
Vectraverse
The multi-dimensional emotional engagement field in which Vectras operate. This warped decision space is influenced by environmental factors, trait decay, and behavioral momentum, affecting goal attraction and session evolution.
VectraIQ
The core behavioral modeling engine that generates and maintains each session's Vectra. It interprets interaction signals into emotional-fluid traits and emits a real-time vector that guides personalization outputs.
Zero-ID Personalization
A methodology that delivers real-time adaptive experiences without storing or referencing identity, login credentials, cookies, or persistent device/session histories.

### Emotional Trait Model

Temperature
Represents the emotional arousal or urgency of the session. Higher temperature indicates faster pacing or impulsiveness; lower temperature reflects hesitancy or fatigue.
Viscosity
Measures emotional or cognitive resistance. High viscosity implies friction or overload; low viscosity reflects ease of movement and readiness to act.
Texture
Reflects behavioral volatility. Smooth textures denote consistent, confident behavior; rough textures indicate instability, reversal patterns, or cognitive dissonance.
Density
Captures interaction coherence and engagement intensity. High density=diverse and focused engagement; low density=scattered or weak interaction.
Confidence (Mass)
A decaying scalar that reflects the user's behavioral clarity or decisiveness. Drives goal persistence or mutation.
Friction Index
A composite metric derived from hesitation, reversals, rage-clicks, and CTA avoidance—used to detect behavioral resistance or objection risk.
Volatility
A measure of session instability, derived from abrupt gesture or tone changes. High volatility may trigger suppression, tone softening, or mutation.
Elasticity
Reflects rebound capacity. High elasticity indicates emotional recoverability (e.g., from friction or doubt); low elasticity dampens engagement re-entry.

### Engine Definitions

IntentIQ
The real-time goal classification and mutation engine. Continuously evaluates session behavior and confidence decay to reclassify engagement goals (e.g., from “Convert” to “Reassure”).
MomentIQ
The tone and timing orchestration layer. Determines how, when, and in what tone content, offers, and messages are presented based on emotional readiness and context.
AffordIQ
The offer logic and economic inference engine. Computes an anonymous Affordability Index (AI) and Economic Impact Score (EIS) to govern offer types, framing, and risk-aware incentives.
BonusIQ
The reward and gamification module. Triggers session-based incentives in emotionally and economically aligned moments—modulating reward visibility, type, and framing.
RecallIQ
The privacy-safe reinforcement learning engine. Continuously tunes mutation thresholds, tone softening, reward exposure, and decay rates based on anonymized in-session outcomes.
MutateIQ
A specialized sub-engine that models the probability, tension, and reversibility of goal mutation events using deformation pressure and behavioral thresholds.
AmbientIQ
Personalization engine for passive or semi-interactive environments (e.g., signage, hotel displays), using ambient and environmental signals to adapt tone and content.
VoiceIQ
Applies emotional trait inference and tone modulation to voice assistant interactions, adjusting language complexity, pacing, and follow-up strategy without voice identity.
SiteIQ
Real-time, privacy-first personalization for anonymous web sessions, using scroll, hover, and dwell signals to adapt CTAs, tone, and layout in-session.
AdIQ
Identity-free ad personalization engine that modulates ad tone, CTA style, and creative delivery based on session-local emotional trait vectors.
MedIQ
A compliance-sensitive personalization engine within the XyloIQ platform, optimized for healthcare, clinical, and emotionally regulated environments. MedIQ interprets in-session behavioral signals—such as consent hesitation, risk-page revisits, or interaction silence—to dynamically adjust tone, delay call-to-action prompts, and suppress reward or escalation logic in emotionally fragile moments. It operates in full compliance with HIPAA, FERPA, and GDPR, and ensures that no identity, medical data, or persistent history is used or stored. MedIQ also serves as the first deployment of a broader regulatory-aware emotional adaptation framework.
RegIQ
A generalized regulatory-aware emotional intelligence layer that governs tone, content pacing, and decision logic in environments where legal, ethical, or compliance standards require heightened sensitivity. RegIQ can be deployed in domains such as healthcare (via MedIQ), finance (e.g., FinIQ), law (e.g., LegIQ), and public services. It modulates trait thresholds and suppresses engagement intensity during high-risk, high-impact, or emotionally delicate interactions, using a zero-ID, privacy-compliant behavioral inference model. RegIQ may also enforce enterprise-defined override rules and tone restrictions based on jurisdiction, regulation type, or emotional volatility.
SensIQ
A behavioral and emotional modulation engine within the XyloIQ platform, designed specifically for emotionally sensitive and consent-relevant digital engagement environments such as adult content platforms, relationship-focused interfaces, and sexual wellness applications. SensIQ interprets signals of hesitation, reversal, fatigue, and cognitive dissonance to modulate tone, suppress escalation, delay calls-to-action, and enforce ethical engagement pacing. It ensures that emotionally fragile states—such as withdrawal after volatility, compulsive interaction loops, or tone misalignment—trigger softening, delay, or silence responses. SensIQ operates entirely within session boundaries, requires no identity or history, and is intended to promote user agency, emotional alignment, and privacy-preserving interaction in high-sensitivity environments.

### Enterprise & Licensing Infrastructure

### Vectra Analytics Dashboard

A privacy-safe, enterprise-facing analytics and reporting module within the XyloIQ platform. The Vectra Analytics Dashboard aggregates and visualizes session-local emotional data—including friction clusters, goal mutation patterns, CTA hesitations, tone transitions, and reward cadence—without using identity, cookies, or persistent profiles. It enables brands, partners, and administrators to evaluate emotional system performance, tone effectiveness, and user experience quality through non-identifying metrics and compliance-safe explanation tokens. All visualizations are based on ephemeral Vectra trait vectors and are discarded post-reporting.

### Emotional Resonance Score

A session-local, scalar or composite metric calculated by the XyloIQ platform to evaluate the emotional alignment between system interventions (e.g., tone shifts, offer logic, reward cadence) and user trait deltas. The Emotional Resonance Score reflects how effectively the system's outputs matched the user's inferred emotional posture and can be aggregated for enterprise reporting, experience optimization, or tone calibration analytics-without storing identity or behavioral history.

### Friction Cluster

A session-local grouping of behavioral signals and emotional trait patterns that indicate concentrated areas of user hesitation, reversal, or resistance. Friction Clusters are detected when elevated friction, volatility, or viscosity traits repeatedly align with specific interface elements, decision points, or content modules. These clusters inform enterprise dashboards about where emotional resistance is most likely to occur, enabling layout optimization, tone adjustment, or CTA pacing refinement-without requiring identity, cross-session tracking, or persistent behavioral storage.

### Engine Communication & Coordination

Multi-Agent Tone Arbitration
A coordination mechanism within the XyloIQ platform that governs tone consistency, escalation pacing, and emotional safety across interactions involving two or more AI agents or large language models (LLMs). When multiple agents participate in a session—such as handoff flows between chatbots, support triage bots, or collaborative LLMs—Multi-Agent Tone Arbitration uses Vectra-derived emotional trait vectors to align tone across agents. It resolves emotional conflicts by prioritizing the most fragile or volatile Vectra state, suppresses contradictory tone outputs, and ensures soft-ramp engagement strategies during emotionally sensitive transitions. All tone arbitration occurs without identity, message content storage, or cross-agent profiling.
Trait Token
A non-identifying, session-local data packet generated by the VectraIQ engine, containing a structured snapshot of the current emotional state of a session. A Trait Token may include scalar values for traits such as temperature, confidence, viscosity, friction, or volatility, and is used to communicate emotional posture across engines, surfaces, or AI agents. Trait Tokens do not contain identity, message content, or persistent history, and are discarded after use. In multi-agent environments, Trait Tokens enable tone alignment, response modulation, and goal coordination without violating user privacy or requiring centralized tracking.
Anticipatory Vectra Modeling
A predictive emotional simulation framework within the XyloIQ platform that forecasts likely future emotional states before they are behaviorally confirmed. Using current trait deltas, decay velocity, engagement rhythm, and session archetype alignment, the system projects a future Vectra—an anticipatory emotional profile—used to preload tone states, delay call-to-action exposure, or suppress escalation logic. This enables the system to initiate soft transitions and emotional stabilization before mutation thresholds are crossed, ensuring seamless and emotionally congruent experiences. All anticipatory Vectras are session-local, discarded after use, and never rendered to the user interface.

### Models, Metrics, and Frameworks

Confidence Decay Model
A time-weighted formula that reduces confidence in an inferred goal over time without reinforcement. Drives strategic reclassification of intent.
Mutation Threshold
A dynamically tuned cutoff at which a goal is reclassified (e.g., due to trait decay, volatility, or friction spike).
Reversal Logic
A soft-ramp process by which a previously mutated goal may be restored if confidence rebounds and friction subsides.
Affordability Index (AI)
A real-time, scalar estimate of inferred price sensitivity, derived from behaviors such as coupon use, checkout hesitation, and product tier browsing.
Economic Impact Score (EIS)
A session-local score modeling the platform's potential ROI of a personalized incentive or offer, considering margin, inventory, and emotional alignment.
Reward Readiness Score (RRS)
BonusIQ's composite readiness metric for determining whether a reward should be triggered, delayed, or suppressed.
Compliance Token Layer (CTL)
A non-identifying, session-local audit trail capturing decisions, rationale, tone shifts, reward triggers, and mutation events for transparency and governance.

### Deployment Concepts.

Session Token/Trait Token
A non-persistent identifier carrying real-time session state—such as emotional traits, mutated goals, and reward status—between surfaces or engines.
Cross-Surface Continuity
The ability to persist session state and tone across platforms (e.g., from signage to mobile) using non-identifying context tokens.
Federated Learning
Local, on-device learning where outcome data is anonymized and used to tune central models without transmitting raw behavioral signals.
Offline Fallback Mode
A localized engine configuration that continues operating in low- or no-connectivity environments using cached logic and session-local trait analysis.

1. A system for real-time behavioral personalization comprising: a VectraIQ engine configured to generate a session-local deformable structure with emotional traits including temperature, viscosity, confidence, friction, and texture; a trait computation module updating said traits from behavioral signals; and a personalization engine modulating tone, CTA timing, and offer framing without identity or tracking.

2. The system of claim 1, wherein each trait decays toward a baseline unless reinforced.

3. The system of claim 1, wherein viscosity exceeding a threshold suppresses offer exposure.

4. The system of claim 1, wherein confidence decay triggers reward deferral or suppression.

5. The system of claim 1, wherein friction is calculated from CTA avoidance, reversal loops, and input hesitation.

6. A personalization engine comprising a trait decay model and a goal classification system that mutates session goals from Convert to Delay, Educate, or Reassure based on trait deltas.

7. The system of claim 6, wherein Emotional Mutation Readiness Score (EMRS) is used to evaluate urgency.

8. The system of claim 6, wherein mutation reversal occurs when confidence rebounds.

9. The system of claim 6, wherein decay constants are modulated by RecallIQ.

10. The system of claim 6, wherein temperature decay accelerates during high ambient noise.

11. The system of claim 6, wherein goal mutation logic replaces A/B testing.

12. The system of claim 6, wherein goal path success is scored for reinforcement learning.

13. A tone modulation engine that classifies session tone from VectraIQ traits and activates tone modes including Assertive, Reassuring, or Minimalist.

14. The system of claim 13, wherein Tone Activation Score (TAS) is used to select tone.

15. The system of claim 13, wherein a Micro-Hesitation Index governs CTA delay.

16. The system of claim 13, wherein volatility spikes suppress urgency tones.

17. The system of claim 13, wherein tone reactivation follows a soft-ramp sequence.

18. The system of claim 13, wherein tone overrides are synchronized with mutation events.

19. A middleware system for emotional modulation of LLM output based on session traits including confidence, viscosity, and temperature.

20. The system of claim 19, wherein temperature modulates sentence length and intensity.

21. The system of claim 19, wherein viscosity slows pacing and inserts pauses.

22. The system of claim 19, wherein confidence modulates certainty and hedging.

23. The system of claim 19, wherein a rationale token is included in LLM responses.

24. The system of claim 19, wherein trait tokens guide creative selection in ad rendering.

25. The system of claim 24, wherein urgency is suppressed when friction is high.

26. The system of claim 24, wherein ad copy is reframed based on tone tokens.

27. A voice interface engine comprising a trait extractor from voice rhythm and syntax.

28. The system of claim 27, wherein elevated friction triggers a goal mutation.

29. The system of claim 27, wherein tone softening occurs during rephrased queries.

30. The system of claim 27, wherein CTA is delayed when viscosity exceeds threshold.

31. The system of claim 27, wherein conversation handoff includes non-ID tone token.

32. The system of claim 27, wherein reward prompts are suppressed under hesitation.

33. A system for cross-surface continuity comprising a Vectra token carrying goal, tone, and reward state.

34. The system of claim 33, wherein token is passed via QR, deep link, or NFC.

35. The system of claim 33, wherein token includes session-local decay timers.

36. The system of claim 33, wherein receiving surfaces interpret tokens to align UX tone.

37. The system of claim 33, wherein cross-brand interpretation is federated and scoped.

38. The system of claim 33, wherein token handoff occurs without cookies or persistent tracking.

39. A modular personalization platform comprising VectraIQ, IntentIQ, MomentIQ, BonusIQ, AffordIQ, and RecallIQ—each licensable independently.

40. The system of claim 39, wherein each engine exposes a scoped API.

41. The system of claim 39, wherein APIs are stripped of identity and history.

42. The system of claim 39, wherein override inputs modulate goal or tone in real time.

43. The system of claim 39, wherein trait exposure is redacted by field-of-use or deployment class.

44. The system of claim 39, wherein each module operates as a plug-in for third-party environments.

45. The system of claim 39, wherein override signals are logged as rationale tokens.

46. The system of claim 39, wherein token-access privileges are scoped by surface or compliance domain.

47. The system of claim 39, wherein override constraints apply soft caps to emotional escalation.

48. The system of claim 39, wherein simulation mode disables all personalization outputs and logs diagnostic traits only.

49. A reward logic engine (BonusIQ) that determines eligibility based on VectraIQ state.

50. The system of claim 49, wherein Reward Readiness Score (RRS) gates exposure.

51. The system of claim 49, wherein high friction suppresses gamified rewards.

52. The system of claim 49, wherein symbolic rewards are used under high volatility.

53. The system of claim 49, wherein delay logic is based on MHI+Viscosity.

54. The system of claim 49, wherein reward animation cadence is scaled to temperature.

55. The system of claim 49, wherein economic gating occurs via AffordIQ EIS values.

56. The system of claim 49, wherein re-exposure is allowed after tone and confidence recovery.

57. A compliance token layer logging tone shifts, goal changes, and reward logic with trait state but no user ID.

58. The system of claim 57, wherein rationale tokens include time, trait delta, and adaptation summary.

59. The system of claim 57, wherein explanations are exposed via API for audits.

60. A federated learning engine (RecallIQ) aggregating session outcome scores with no identity retention.

61. The system of claim 60, wherein decay rates are adjusted based on anonymized success patterns.

62. The system of claim 60, wherein learning is scoped by session archetype.

63. The system of claim 60, wherein all updates use differential privacy protocols.

64. The system of claim 60, wherein update deltas are capped to prevent drift or manipulation.

65. A personalization engine operating fully offline using precompiled mutation graphs and fallback tone tables.

66. The system of claim 65, wherein all trait logic executes on-device and expires at session close.

67. The system of claim 65, wherein simulation mode injects synthetic Vectra states for QA.

68. The system of claim 65, wherein synthetic sessions log no production state.

69. The system of claim 65, wherein reward logic is replaced with symbolic messaging during offline mode.

70. The system of claim 65, wherein mutation logic uses fixed thresholds in kiosk or signage environments.

71. The system of claim 65, wherein ambient display tone is inferred from projected Vectra states.

72. The system of claim 65, wherein projected Vectras include default trait vectors by time-of-day and context.

73. The system of claim 65, wherein projected Vectras are used to suppress urgency tone during crowd stress.

74. The system of claim 65, wherein simulated sessions are used to benchmark compliance flags or explainability logic.

75. The system of claim 65, wherein edge Vectras sync updates to RecallIQ using differential privacy upon reconnection.
